(19) United States
(12) Patent Application Publication
(10) Pub. No.: US 2026/0210884 A1
(43) Pub. Date: Jul. 23, 2026

(54) NETWORKED RF MATERIAL DEVICES FOR SUBSTANCE DETECTION VIA OPPOSED PERIMETER SENSORS

(71) Applicant: QUANTUM IP, LLC, Stuart, FL (US)

(72) Inventors: Robert J. Short, JR., Stuart, FL (US); Lee Duke, Stuart, FL (US)

(21) Appl. No.: 18/934,569

(22) Filed: Nov. 1, 2024

Related U.S. Application Data
(60) Provisional application No. 63/667,598, filed on Jul. 3, 2024.

(51) Int. Cl. G01N 24/08

(52) U.S. Cl. CPC G01N 24/084

(57) ABSTRACT

A method includes extracting a first detection entry from a target database, the first detection entry including a first identifier of a first RF detection device, wherein the first RF detection device is located at a first side of a perimeter; determining a second RF detection device located at a second side of the perimeter; searching for a second detection entry associated with the second RF detection device; and, if the first detection entry and the second detection entry both include detection data that indicates the presence of a target material, storing an indication that the target material is within the perimeter; otherwise, store an indication that the target material is outside of the perimeter.

### CROSS-REFERENCE TO RELATED APPLICATIONS

This application claims the benefit of U.S. Provisional Application No. 63/667,598, filed Jul. 3, 2024, which is incorporated herein by reference.

### FIELD OF THE DISCLOSURE

The present disclosure is generally related to material detection and, more specifically, networked RF material devices for substance detection via opposed perimeter sensors.

### BACKGROUND

Currently, ensuring that controlled substances, explosives, and other hazardous materials are accurately detected within a designated perimeter is challenging, as traditional methods may lack the precision and reliability required for real-time surveillance and security. Existing detection systems often produce false positives and negatives, which can lead to unnecessary alarms or undetected threats, compromising the effectiveness of perimeter security. Also, combining various detection technologies, such as RF magnetometers and networked detectors, into a cohesive system that provides accurate and reliable substance identification is a complex task that requires advanced signal processing and seamless communication between components. Developing a system that can remotely process signals to ensure compact and accurate point-of-use devices is necessary to enhance the efficiency and practicality of deploying detection units in various environments. Lastly, achieving non-invasive and instantaneous detection of hazardous materials within a perimeter is helpful for maintaining security without disrupting normal operations or causing undue alarm among personnel and visitors. Implementing a system that allows for real-time monitoring and immediate response to detected threats is essential for preventing unauthorized substances from entering secure areas and ensuring the safety of personnel and assets. Thus, there is a need for networked RF material devices for substance detection via opposed perimeter sensors.

### SUMMARY

According to one aspect, a system includes a plurality of RF detection devices, each RF detection device including an interface configured to access a material database associating each of a plurality of materials with one or more corresponding resonance frequencies; an RF transmitter configured to, for each material of at least a subset of the plurality of materials in the material database, transmit into an environment an RF signal at a resonance frequency for each material; an RF receiver configured to receive a response signal from the environment for each RF signal; and a first set of one or more processors configured to analyze each response signal for detection data including resonance characteristics that indicate a presence of each material and, if the presence of each material is indicated, store, in a target database, a detection entry including at least: an identifier of an RF detection device receiving the response signal; and the detection data. The system also includes a second set of one or more processors configured to extract a first detection entry from the target database, the first detection entry including a first identifier of a first RF detection device, wherein the first RF detection device is located at a first side of a perimeter; determine a second RF detection device located at a second side of the perimeter; search for a second detection entry associated with the second RF detection device; and if the first detection entry and the second detection entry both include detection data that indicates the presence of a target material, store an indication that the target material is within the perimeter; otherwise, store an indication that the target material is outside of the perimeter.

In some embodiments, the second set of one or more processors determine the second RF detection device by referencing a perimeter database associating each of a first plurality of RF detection devices located on one side of one or more perimeters with each of a second plurality of RF detection devices located on another side of the one or more perimeters.

In some embodiments, the first detection entry further includes a location of the first RF detection device and a timestamp.

In some embodiments, the second set of one or more processors determine the second RF detection device with reference to the location of the first RF detection device in the first detection entry based on the location of the first RF detection device and/or the timestamp.

In some embodiments, the detection data includes one or more of a signal strength parameter and/or a frequency parameter.

In some embodiments, the second set of one or more processors use the signal strength parameter and/or frequency parameter to determine one or more of a proximity and/or concentration of the target material.

In some embodiments, the detection data includes data regarding one or more environmental conditions that affect RF signal propagation and/or detection accuracy.

In some embodiments, the one or more environmental conditions include one or more of temperature, humidity, and atmospheric pressure.

In some embodiments, the RF transmitter of at least one RF detection device adjusts a frequency of the RF signal based on at least one of the one or more environmental conditions.

In some embodiments, the second set of one or more processors are configured to generate a report of one or more target materials identified within one or more perimeters.

In some embodiments, a second set of one or more processors configured to triangulate a location of the target material using known locations of the first RF detection device and the second RF detection device.

According to another aspect, a method includes providing plurality of RF detection devices, each RF detection device comprising: an interface configured to access a material database associating each of a plurality of materials with one or more corresponding resonance frequencies; an RF transmitter configured to, for each material of at least a subset of the plurality of materials in the material database, transmit into an environment an RF signal at a resonance frequency for each material; an RF receiver configured to receive a response signal from the environment for each RF signal; and a first set of one or more processors configured to analyze each response signal for detection data including resonance characteristics that indicate a presence of each material and, if the presence of each material is indicated, store, in a target database, a detection entry including at least: an identifier of an RF detection device receiving the response signal; and the detection data. The method also includes extracting a first detection entry from the target database, the first detection entry including a first identifier of a first RF detection device, wherein the first RF detection device is located at a first side of a perimeter; determining a second RF detection device located at a second side of the perimeter; searching for a second detection entry associated with the second RF detection device; and if the first detection entry and the second detection entry both include detection data that indicates the presence of a target material, storing an indication that the target material is within the perimeter; otherwise, store an indication that the target material is outside of the perimeter.

In some embodiments, determining the second RF detection device includes referencing a perimeter database associating each of a first plurality of RF detection devices located on one side of one or more perimeters with each of a second plurality of RF detection devices located on another side of the one or more perimeters.

In some embodiments, the first detection entry further includes a location of the first RF detection device and a timestamp.

In some embodiments, determining the second RF detection device includes determining the second RF detection device with reference to the location of the first RF detection device in the first detection entry based on the location of the first RF detection device and/or the timestamp.

In some embodiments, the detection data includes one or more of a signal strength parameter and/or a frequency parameter.

In some embodiments, the method further includes determining one or more of a proximity and/or concentration of the target material based on the signal strength parameter and/or frequency parameter.

In some embodiments, the detection data includes data regarding one or more environmental conditions that affect RF signal propagation and/or detection accuracy.

In some embodiments, the one or more environmental conditions include one or more of temperature, humidity, and atmospheric pressure.

In some embodiments, the RF transmitter of at least one RF detection device adjusts a frequency of the RF signal based on at least one of the one or more environmental conditions.

In some embodiments, the method further includes generating a report of one or more target materials identified within one or more perimeters.

In some embodiments, the method further includes triangulating a location of the target material using known locations of the first RF detection device and the second RF detection device.

### BRIEF DESCRIPTION OF THE DRAWINGS

FIG. 1 is a schematic diagram of a Networked RF Material Device for Substance Detection via Opposed Perimeter Sensors, according to an embodiment.

FIG. 2 is a flow chart of a method performed by a Detection Module, according to an embodiment.

FIG. 3 is a flow chart of a method performed by a Transfer Module, according to an embodiment.

FIG. 4 is a flow chart of a method performed by a Base Module, according to an embodiment.

FIG. 5 is a flow chart of a method performed by a Data Collection Module, according to an embodiment.

FIG. 6 is a flow chart of a method performed by an ID Module, according to an embodiment.

FIG. 7 is a flow chart of a method performed by a Report Module, according to an embodiment.

FIG. 8 illustrates a Perimeter Database, according to an embodiment.

FIG. 9 illustrates a Target Database, according to an embodiment.

FIG. 10 illustrates a Report Database, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

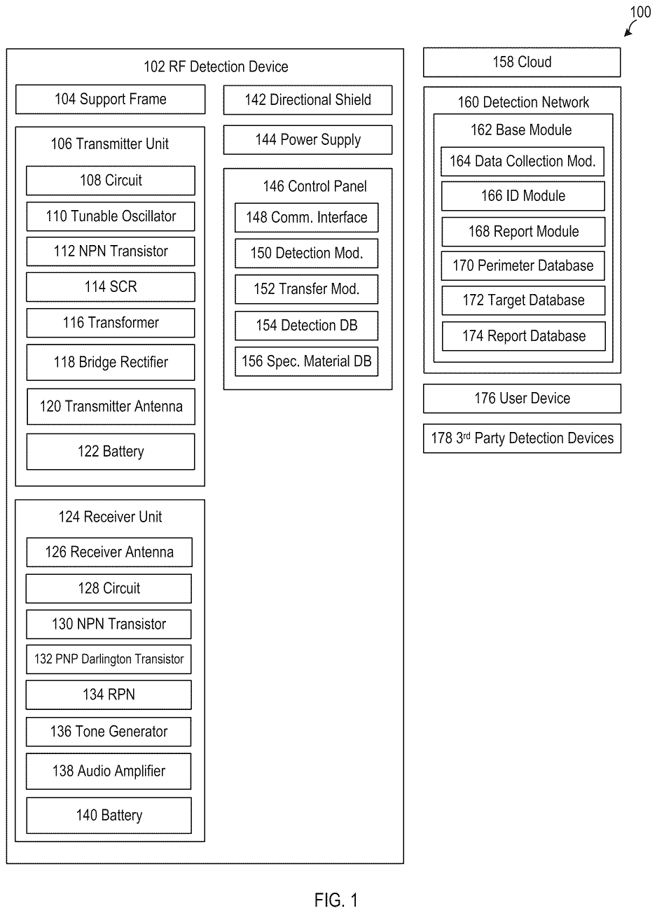

FIG. 1 illustrates a system 100 including networked RF material devices for substance detection via opposed perimeter sensors. This system 100 includes an RF detection device 102, which may be a specialized system designed to detect and identify specific materials based on their unique resonance frequencies when exposed to electromagnetic signals. The RF detection device 102 incorporates an RF detection system similar to that disclosed in patent U.S. Pat. No. 11,493,494B2, employing RF signals for the detection and identification of materials based on their resonance characteristics. The RF detection device 102 may operate by transmitting RF signals into the environment and analyzing the received signals for resonance characteristics that indicate the presence of a target material. The RF detection device 102 may be designed to detect a target material based on its resonance properties with specific RF frequencies. It utilizes the principle that materials resonate at particular frequencies when exposed to external RF signals, allowing for their identification and potential quantification. The RF detection device 102 may include a transmitter unit 106, a receiver unit 124, a control panel 146, a transmitter antenna 120, a receiver antenna 126, a directional shield 142, and a power supply 144. Upon activation, the control panel 146 initializes the system 100, powering up the transmitter unit 106, the receiver unit 124, and associated electronics. The control panel 146 may instruct the transmitter unit 106 to generate RF signals at specified frequencies, such as 180 Hz, 1800 Hz, etc., and amplitudes, such as 320V, 160V, etc., known to resonate with a target material. The transmitter unit 106 emits these RF signals through the transmitter antenna 120 into the testing environment. The receiver unit 124 captures the RF signals using the receiver antenna 126. It then processes the received signals to identify resonance frequencies that indicate the presence of the target material.

Further, embodiments may include a support frame 104, which may be a structural component designed to provide stability and support to various subsystems and components of the RF detection device 102. The support frame 104 may provide proper alignment and positioning of the components, such as the transmitter unit 106, receiver unit 124, and control panel 146. The support frame 104 may provide mounting points and secure attachment locations for subsystems such as the transmitter unit 106, receiver unit 124, and control panel 146. By maintaining precise alignment and stability, the support frame 104 may minimize vibrations and unwanted movements that could interfere with the accuracy of RF signal transmission and reception. In some embodiments, the support frame 104 may be constructed from durable materials such as metal alloys or rigid polymers.

Further, embodiments may include a transmitter unit 106, which may include an electronic circuit 108, powered by a battery 122, such as a 12-volt, 1.2 amp battery, with a regulated output of nine volts. The circuit 108 may use a 555 timer as a tunable oscillator 110 to generate a pulse rate. The output of the oscillator 110 is fed in parallel to an NPN transistor 112 and a silicon-controlled rectifier or SCR 114. The transistor may be used as a common emitter amplifier stage driving a transformer 116. The transformer 116 may be used to step up the voltage as needed. The balanced output of the transformer 116 feeds a bridge rectifier 118. The rectified direct current flows through a 100 K, three-watt resistor to terminal B of the transmitter antenna 120. A plurality of resistors and capacitors may fill in the circuit 108. In some embodiments, the transmitter antenna 120 may be formed from a coil of about 25 meters of 14-strand wire tightly wound around a one-centimeter PVC core. The transmitter antenna 120 may be, in one exemplary embodiment, in a 1″×3″ configuration at the bottom end of the support frame 104. In some embodiments, the transmitter antenna 120 may be shielded approximately 315 degrees with the directional shield 142, formed from aluminum and copper, leaving a two-inch opening. Terminal A of the transmitter antenna 120 is switched to ground through the SCR 114. The SCR 114 is “fired” by the output of the 555 timer. This particular configuration generates a narrow pulsed waveform to the transmitter antenna 120 at a pulse rate as set by the 555 timer. Power is delivered through the 3 W resistor. Frequencies down to 4 Hz are achieved by an RC network containing a 100 K pot, a switch, and one of two capacitive paths. The circuit 108 may provide simple RC-controlled timing and deliver pulses to the primary of a step-up transformer 116, the output of which is full-wave rectified and fed to the transmitter antenna 120. The pulse rate is adjustable from the low Hz range to the low kHz range. The sharp pulses at low repetition frequencies yield a wide spectrum of closely spaced lines. The pulse rate is adjusted depending on the material to be detected. In some embodiments, one or more portions of the transmitter unit 106 may be implemented in an analog circuit configuration, a digital circuit configuration, or some combination thereof. In one example, the analog configuration may include one or more analog circuit components, such as, but not limited to, operational amplifiers, op-amps, resistors, inductors, and capacitors. In another example, the digital configuration may include one or more digital circuit components, such as, but not limited to, microprocessors, logic gates, and transistor-based switches. In some instances, a given logic gate may include one or more electronically controlled switches, such as transistors, and the output of a first logic gate may control one or more logic gates disposed “downstream” from the first logic gate.

Further, embodiments may include a circuit 108, which may be an assembly of electronic components that generate, modulate, and transmit radio frequency, RF, signals. The circuit 108 may include oscillators 110, amplifiers, modulators, and other components that work together to produce a specific RF signal, which can then be transmitted through the transmitter antenna 120. The circuit 108 may include an oscillator 110, which generates a stable RF signal at a specified frequency. This frequency is selected based on the resonance characteristics of the target material. For example, the system 100 may operate at 180 Hz or 1800 Hz, depending on the specific requirements of the detection task. Once generated, the RF signal is fed into an amplifier. The amplifier boosts the signal strength to a level suitable for transmission over the required distance. This ensures that the signal can propagate through various media and reach the receiver unit 124 effectively. Modulation circuits are used to encode information into the RF signal. This may involve varying the amplitude, frequency, or phase of the signal to carry specific data related to the detection process. Modulation ensures that the transmitted signal can be uniquely identified and distinguished from other signals in the environment. The circuit 108 may include power control components that regulate the voltage and current supplied to the oscillator 110 and amplifier. This ensures consistent signal output and helps in managing the power consumption of the device. In some embodiments, the transmitter unit 106 may operate at voltages such as 160V and 320V, with adjustments made to optimize detection performance. The amplified and modulated RF signal is then routed to the transmitter antenna 120. The transmitter antenna 120 converts the electrical signal into an electromagnetic wave that can propagate through the air or other media. In some embodiments, the circuit 108 may be integrated with the device's control systems, allowing for automated adjustments based on pre-set parameters or operator inputs.

Further, embodiments may include a tunable oscillator 110, which may be a type of electronic component that generates a periodic waveform with a frequency that can be adjusted or tuned over a specific range. The tunable oscillator 110 within the transmitter unit 106 may be utilized to generate the RF signal that will be transmitted by the RF detection device 102. The tunable oscillator 110 in the transmitter unit 106 may be employed to produce an RF signal whose frequency can be precisely controlled. By adjusting the control inputs, the frequency of the output signal can be varied, allowing the system 100 to adapt to different detection requirements and environmental conditions. This tuning mechanism may ensure that the oscillator 110 produces a signal at the correct frequency needed for effective resonance with the target materials. By tuning the oscillator 110 to specific frequencies, the system 100 may detect various substances based on their unique resonant properties. The tunable oscillator 110 may work in conjunction with the control panel 146, which sends control signals to adjust the oscillator's 110 frequency as needed. The tunable oscillator 110 may act as the core signal generation component in the transmitter unit 106. When the control panel 146 determines the required frequency for detection, it sends control signals to the tunable oscillator 110. The oscillator 110 then adjusts its frequency accordingly, generating an RF signal that matches the desired parameters. The tunable oscillator 110 may be connected to other components within the transmitter unit 106, such as the SCR 114 and the transformer 116. The SCR 114 manages the power supply to the oscillator 110, ensuring it receives the correct voltage. The transformer 116 steps up the voltage to the appropriate level required by the oscillator 110.

Further, embodiments may include an NPN transistor 112, which may be a type of bipolar junction transistor, BJT, that consists of three layers of semiconductor material: a layer of p-type material, the base layer, sandwiched between two layers of n-type material, the emitter and the collector. When a small current flows into the base, it allows a larger current to flow from the collector to the emitter, effectively acting as a current amplifier or switch in electronic circuits. The NPN transistor 112 in the transmitter unit 106 amplifies the RF signal generated by the oscillator 110. The NPN transistor 112 may operate in its active region, where a small input current applied to the base controls a larger current flowing from the collector to the emitter. This amplification process ensures that the RF signal reaches a sufficient power level for effective transmission. In some embodiments, the NPN transistor 112 may also function as a switch, controlling the flow of current within the circuit 108. When the base-emitter junction is forward-biased, a small voltage is applied, and the NPN transistor 112 allows current to flow from the collector to the emitter. This switching action is used to modulate the RF signal, encoding information onto the carrier wave as required for the detection process. Proper biasing of the NPN transistor 112 is helpful for stable operation. In some embodiments, resistors may be used to establish the correct biasing conditions to ensure that the NPN transistor 112 operates in its linear region for amplification or in saturation/cutoff regions for switching. The biasing circuit ensures that the NPN transistor 112 responds predictably to input signals, maintaining signal integrity. In some embodiments, the NPN transistor 112 may be involved in modulating the RF signal. By varying the input current to the base, the amplitude, frequency, or phase of the RF signal can be modulated. This modulation is critical for encoding the detection data onto the transmitted signal, allowing for accurate identification and analysis. In some embodiments, the NPN transistor 112 may be integrated into the broader transmitter circuit 108, working in conjunction with other components such as capacitors, inductors, and resistors. This integration ensures that the NPN transistor's 112 amplification and switching actions are synchronized with the overall signal generation and transmission process. The circuit 108 design may leverage the NPN transistor's 112 properties to achieve the desired RF output characteristics.

Further, embodiments may include an SCR 114 or silicon-controlled rectifier, which may be a type of semiconductor device that functions as a switch and rectifier, allowing current to flow only when a control voltage is applied to its gate terminal. The SCR 114 is utilized within the transmitter unit 106 to manage and control the power delivery to the RF signal generation components. The SCR 114 in the transmitter unit 106 may be employed to control the flow of power to the RF oscillator 110 circuit 108. By applying a gate signal to the SCR 114, it switches from a non-conductive state to a conductive state, allowing current to pass through and power the oscillator 110. This control mechanism ensures that the oscillator 110 only receives power when required, thereby conserving energy and preventing unnecessary power dissipation. The SCR 114 may act as a switching element in the transmitter unit 106. When the control panel 146 determines that the RF signal needs to be generated, a gate voltage is applied to the SCR 114. This triggers the SCR 114 to conduct, completing the circuit and enabling current to flow to the RF oscillator 110. The SCR 114 may ensure that sufficient current is supplied to the oscillator 110 to produce a strong RF signal without being damaged by the high power levels. The gate terminal of the SCR 114 may be connected to the control panel 146, which manages the timing and application of the gate signal. This integration ensures that the SCR 114 is activated precisely when the RF signal needs to be transmitted, in sync with the overall operation of the RF detection device 102. The control panel 146 sends the appropriate signal to the SCR 114, ensuring accurate timing and efficient power usage. The SCR 114 may also serve as a protective component in the transmitter unit 106. Controlling the power flow prevents overloading and potential damage to the RF oscillator 110 and other sensitive components. If the system 100 detects any abnormal conditions, the control panel 146 can withhold the gate signal, keeping the SCR 114 in a non-conductive state and thereby cutting off power to protect the circuit 108.

Further, embodiments may include a transformer 116, which is an electrical device that transfers electrical energy between two or more circuits through electromagnetic induction. The transformer 116 is utilized within the transmitter unit 106 to manage and control the voltage levels required for the RF signal generation and transmission. The transformer 116 in the transmitter unit 106 may be employed to step up or down the voltage as needed to ensure the proper operation of the RF oscillator 110 circuit 108. By adjusting the voltage levels, the transformer 116 ensures that the components within the transmitter unit 106 receive the appropriate voltage for efficient functioning. The transformer 116 may act as a voltage regulation element in the transmitter unit 106. When the control panel 146 determines that the RF signal needs to be generated, the transformer 116 adjusts the input voltage to the desired level. This adjustment involves converting the primary winding voltage to a higher or lower voltage in the secondary winding, depending on the requirements of the RF oscillator 110. The transformer 116 ensures that the oscillator 110 receives a stable and appropriate voltage, which is critical for producing a consistent and strong RF signal. The primary winding of the transformer 116 may be connected to the battery 122, while the secondary winding is connected to the RF oscillator 110. This integration ensures that the transformer 116 can effectively manage the voltage levels needed for RF signal generation. The control panel 146 monitors and regulates the input voltage to the transformer 116, ensuring accurate and efficient voltage conversion and delivery to the RF oscillator 110.

Further, embodiments may include a bridge rectifier 118, which is an electrical device designed to convert alternating current, AC, to direct current, DC, using a combination of four diodes arranged in a bridge configuration. The bridge rectifier 118 is utilized within the transmitter unit 106 to ensure that the RF signal generation components receive a steady and reliable DC power supply. The bridge rectifier 118 in the transmitter unit 106 may be employed to convert the incoming AC voltage from the battery 122 into a DC voltage. By using all portions of the AC waveform, the bridge rectifier 118 provides full-wave rectification, resulting in a more efficient conversion process and producing a smoother and more stable DC output. The bridge rectifier 118 may act as a key power conversion element in the transmitter unit 106. When the control panel 146 determines that the RF signal needs to be generated, the AC voltage supplied to the transmitter unit 106 is passed through the bridge rectifier 118. The bridge rectifier 118 converts the AC voltage into a DC voltage by directing the positive and negative halves of the AC waveform through the appropriate diodes. This process results in a continuous DC voltage output that is used to power the RF oscillator 110 and other critical components. The input terminals of the bridge rectifier 118 may be connected to an AC power supply, while the output terminals provide the rectified DC voltage to the RF oscillator 110 circuit 108. This integration ensures that the bridge rectifier 118 can effectively convert and deliver DC power for RF signal generation. The control panel 146 monitors the output of the bridge rectifier 118, ensuring that the DC voltage is stable and within the desired range for optimal performance.

Further, embodiments may include a transmitter antenna 120, which may be a device that radiates radio frequency, RF, signals generated by the transmitter unit 106 towards a target material. The transmitter antenna 120 may be designed to efficiently transmit the generated RF signals into the surrounding environment and ensure the signals reach the intended target with minimal loss. The transmitter antenna 120 may be responsible for the emission of RF signals for detecting materials at a distance. In some embodiments, the transmitter antenna 120 may operate within a specific frequency range suitable for detecting the atomic structures and characteristics of the target materials. The frequency range may be determined by the system's requirements and the properties of the materials being detected. In some embodiments, the gain of the transmitter antenna 120 may be a measure of its ability to direct the RF energy toward the target. Higher gain antennas focus the energy more effectively, resulting in stronger signal transmission over longer distances. The transmitter antenna 120 gain may be optimized for the operational frequency range. In some embodiments, the radiation pattern of the transmitter antenna 120 describes the distribution of radiated energy in space. For effective material detection, the transmitter antenna 120 may have a directional radiation pattern, concentrating the RF energy in a specific direction to enhance detection accuracy. In some embodiments, impedance matching between the transmitter antenna 120 and the transmitter unit 106 may maximize power transfer and minimize signal response. Proper impedance matching may ensure efficient operation and reduce losses in the transmission path. In some embodiments, the physical design of the transmitter antenna 120 may include configurations such as dipole, patch, or horn antennas, depending on factors such as frequency range, gain, and environmental conditions. In some embodiments, the transmitter antenna 120 may be integrated with the transmitter unit 106 and other system components through connectors and mounting structures to ensure stable and reliable operation, with considerations for minimizing interference and signal loss.

Further, embodiments may include a battery 122, which may be a type of energy storage device that provides a stable and portable power source for the transmitter unit 106. The battery 122 within the transmitter unit 106 may be utilized to supply the electrical energy to the various components involved in generating and transmitting the RF signal. The battery 122 may be designed to store electrical energy and supply it to the respective components as required. The battery 122 may be rechargeable or replaceable cells capable of providing DC voltage. They are selected based on factors such as voltage output and capacity, which may be measured in ampere-hours, Ah, and size to meet the power requirements of each component effectively. In the transmitter unit 106, battery 122 may serve as a portable power source, enabling the generation and transmission of RF signals without requiring a direct connection to an external power supply. The battery 122 may power components such as the oscillator 110 circuit 108, SCR 114, and transformer 116, ensuring continuous operation in various environmental conditions. In some embodiments, the battery 122 used may include lithium-ion, nickel-metal hydride, or other types suitable for portable electronic devices.

Further, embodiments may include a receiver unit 124, which may include the electronic circuit 128. Voltage from the receiver antenna 126 passes through a 10 K gain pot to an NPN transistor 130 used as a common emitter. The output is capacitively coupled to a PNP Darlington transistor 132. A plurality of resistors and capacitors fills in the circuit 128. The output is fed through a RPN 134 to a 555 timer that is used as a voltage-controlled oscillator. A received signal of a given amplitude generates an audible tone at a given frequency. In some embodiments, the output is fed to a tone generator 136, such as a speaker, via a standard 386 audio amp. Sounds can be categorized as “grunts,” “whines,” and a particular form of whine with a higher harmonic notably present. In some embodiments, another indicator of a received signal is used, such as light, vibration, digital display, or analog display, in alternative to or in combination with the sound signal. A battery 140 may be used to power the receiver circuit 128. The receiver circuit 128 may utilize a coherent, direct-conversion mixer, homodyne, with RF gain, yielding a baseband signal centered about DC. After a baseband gain stage, the baseband signal is fed to another timing circuit that functions as a voltage-controlled audio-frequency oscillator. The output of this oscillator is amplified and fed to a speaker. In some embodiments, one or more portions of the receiver unit 124 may be implemented in an analog circuit configuration, a digital circuit configuration, or some combination thereof. In one example, the analog configuration may include one or more analog circuit components, such as, but not limited to, operational amplifiers 138, op-amps, resistors, inductors, and capacitors. In another example, the digital configuration may include one or more digital circuit components, such as, but not limited to, microprocessors, logic gates, and transistor-based switches. In some instances, a given logic gate may include one or more electronically controlled switches, such as transistors, and the output of a first logic gate may control one or more logic gates disposed “downstream” from the first logic gate.

Further, embodiments may include a receiver antenna 126, which may be a device that captures the radio frequency, RF, signals responded from a target material. The receiver antenna 126 may be designed to efficiently receive the responded RF signals and transmit them to the receiver unit 124 for further processing and analysis. The receiver antenna 126 may be responsible for capturing the RF signals that have interacted with the target material. In some embodiments, the receiver antenna 126 may be designed to operate within the same frequency range as the transmitter antenna 120 to ensure compatibility and optimal performance for detecting the atomic structures and characteristics of the target materials. In some embodiments, the sensitivity may be a measurement of the receiver antenna's 126 ability to detect weak signals. A highly sensitive receiver antenna 126 may detect low-power responded signals, enhancing the system's detection capabilities. In some embodiments, the noise figure of the receiver antenna 126 may indicate the level of noise it introduces into the received signal. A lower noise figure may be desirable as it ensures that the captured signals are as clean and strong as possible for accurate processing. In some embodiments, proper impedance matching between the receiver antenna 126 and the receiver unit 124 may minimize signal response and maximize the power transfer from the receiver antenna 126 to the processing unit to ensure efficient and accurate signal reception. In some embodiments, the directional properties of the receiver antenna 126 may determine its ability to capture signals from specific directions to distinguish signals responded from the target material versus other sources of interference. In some embodiments, the gain of the receiver antenna 126 may enhance its ability to receive signals from distant targets. Higher gain receiver antennas 126 can improve the system's ability to detect materials at greater distances. In some embodiments, the physical design of the receiver antenna 126 may include various configurations such as dipole, patch, or parabolic antennas and may be based on factors such as frequency range, gain, and the specific detection requirements. In some embodiments, the receiver antenna 126 may be integrated with the receiver unit 124 and other system components through connectors and mounting structures to ensure stable and reliable operation, with considerations for minimizing interference and signal loss. In some embodiments, the receiver antenna 126 and the transmitter antenna 120 may be a single antenna used by the RF detection device 102.

Further, embodiments may include a circuit 128 within the receiver unit 124, which may be an assembly of electrical components designed to process the received RF signal. The circuit 128 may accurately interpret the RF signals responded to or emitted from the target substances and convert them into data that can be analyzed by the RF detection device 102. The circuit 128 in the receiver unit 124 may be employed to handle signal amplification, filtering, demodulation, and signal processing. When an RF signal is received via the receiver antenna 126, it is typically weak and may contain noise or interference. The first stage of the circuit 128 may involve an amplifier that boosts the signal strength to a level suitable for further processing. This amplification ensures that even weak signals can be analyzed effectively. Next, the circuit 128 may include filtering components that serve to remove unwanted frequencies and noise from the received signal. Filters ensure that only the relevant frequency components of the RF signal are passed through, enhancing the signal-to-noise ratio and improving the clarity of the data. The circuit 128 may also incorporate a demodulator, which extracts the original information-bearing signal from the modulated RF carrier wave. This step interprets the data encoded in the RF signal, allowing the system 100 to identify specific characteristics or signatures of the target substances. In some embodiments, the circuit 128 may include various signal processing components, such as analog-to-digital converters, ADCs, which convert the analog RF signal into digital data. This digital data may then be processed by the control panel 146 or other computational units within the system 100 for detailed analysis. The signal processing may involve algorithms to detect specific patterns, frequencies, or anomalies that indicate the presence of target materials. The components within the circuit 128 interact seamlessly to ensure accurate and efficient signal processing. For example, the amplified signal from the amplifier is passed to the filter, which cleans up the signal before it reaches the demodulator. The demodulated signal is then digitized by the ADC and sent to the control panel 146 for analysis.

Further, embodiments may include an NPN transistor 130, which may be a three-terminal semiconductor device used for amplification and switching of electrical signals. The NPN transistor 130 may consist of three layers of semiconductor material: a thin middle layer, or base, between two heavily doped layers, or emitter and collector. The NPN transistor 130 operates by controlling the flow of current from the collector to the emitter, regulated by the voltage applied to the base terminal. The NPN transistor 130 integrated into the receiver unit 124 may be designed to process incoming RF signals and may operate in a configuration where the base-emitter junction is forward-biased by a small control voltage provided by preceding stages of the circuit 128. The collector of the NPN transistor 130 may be connected to the circuit's 128 supply voltage through a load resistor. When a small current flows into the base terminal, it allows a larger current to flow from the collector to the emitter. This amplification process increases the strength of the received signal, enabling subsequent stages of the circuit 128 to process it more effectively. In the receiver unit 124, the NPN transistor 130 may be employed within amplifier stages where signal gain is beneficial. By controlling the base current, the circuit 128 can modulate the NPN transistor's 130 conductivity and thereby regulate the amplification factor. This capability enhances weak RF signals received by the receiver antenna 126 and prepares them for further processing. In some embodiments, the NPN transistor 130 may be utilized in conjunction with capacitors and resistors to form amplifier circuits tailored to the specific requirements of the RF detection device 102. Capacitors may be used to couple AC signals while blocking DC components, ensuring that only the RF signal is amplified. Resistors set the biasing and operating points of the transistor, optimizing its performance within the circuit 128.

Further, embodiments may include a PNP Darlington transistor 132, which may be a semiconductor device consisting of two PNP transistors 132 connected in a configuration that provides high current gain. The PNP Darlington transistor 132 integrates two stages of amplification in a single package, where the output of the first transistor acts as the input to the second, significantly boosting the overall gain of the circuit 128. The PNP Darlington transistor 132 amplifies weak RF signals received by the receiver antenna 126. The incoming RF signal is fed into the base of the first PNP transistor 132 within the Darlington pair. The PNP Darlington transistor 132, due to its high current gain, allows a much larger current to flow from its collector to the emitter compared to the base current. The output from the collector of the first transistor serves as the input to the base of the second PNP transistor 132 in the Darlington pair. The second PNP transistor 132 further amplifies the signal received from the first stage, again with significant current gain.

Further, embodiments may include an RPN 134, or resistor potentiometer network, which may be an electrical circuit composed of resistors and potentiometers interconnected in a specific configuration to achieve desired electrical characteristics, such as voltage division, signal attenuation, or adjustment of resistance values. Potentiometers, also known as variable resistors, allow for manual adjustment of resistance within the circuit, while resistors set fixed values to control current flow and voltage levels. The RPN 134 in the receiver unit 124 may be configured to adjust signal levels received from the receiver antenna 126 and prepare them for further processing. The RPN 134 consists of resistors and potentiometers connected to achieve precise voltage division and attenuation. By adjusting the potentiometers, operators can fine-tune the signal strength and impedance matching, optimizing signal quality for subsequent stages of signal processing. The RPN 134 ensures that incoming RF signals from the receiver antenna 126 are properly attenuated and scaled to match the input requirements of downstream electronics. This calibration process maintains signal integrity and fidelity throughout the reception and decoding process. In some embodiments, the potentiometers within the RPN 134 may allow for manual adjustment of signal parameters such as amplitude and impedance, enabling operators to optimize signal reception based on environmental conditions and operational requirements.

Further, embodiments may include a tone generator 136, which may be a type of electronic device that produces audio signals or tones to alert the user of specific conditions. The tone generator 136 within the receiver unit 124 is utilized to generate audible alerts when the RF detection device 102 identifies the presence of target materials. The tone generator 136 in the receiver unit 124 may be employed to create specific tones that serve as audible indicators for the user. By generating these tones, the tone generator 136 provides immediate feedback to the operator, signaling the detection of target materials in real time. The tone generator 136 may ensure that the operator is promptly informed of detections without needing to constantly monitor visual displays. The tone generator 136 produces distinct sounds that correspond to different detection events, making it easier for the operator to understand the system's status and respond accordingly. The tone generator 136 may act as a critical alerting component within the receiver unit 124. When the control panel 146 determines that the RF signal corresponds to a detected target material, it sends a signal to the tone generator 136. This triggers the tone generator 136 to produce a sound, alerting the operator to the detection event.

Further, embodiments may include an audio amplifier 138, which may be a type of electronic device designed to increase the amplitude of audio signals. The audio amplifier 138 within the receiver unit 124 may be utilized to boost the audio signals generated by the tone generator 136, ensuring that the output sound is sufficiently loud and clear for the operator to hear. The audio amplifier 138 in the receiver unit 124 may be employed to enhance the volume and clarity of the audio tones produced by the tone generator 136. By amplifying these audio signals, the audio amplifier 138 ensures that the operator receives audible alerts even in noisy environments, thus improving the overall effectiveness of the detection system. The audio amplifier 138 may act as an intermediary component between the tone generator 136 and the output device, such as a speaker. When the tone generator 136 produces an audio signal, this signal is sent to the audio amplifier 138. The audio amplifier 138 then boosts the signal's power, making it strong enough to drive the speaker and produce an audible sound. The audio amplifier 138 is connected to other components within the receiver unit 124, including the tone generator 136 and the speaker. It receives the low-power audio signals from the tone generator 136 and amplifies them to a level suitable for driving the speaker.

Further, embodiments may include a battery 140, which may be a type of energy storage device that provides a stable and portable power source for the receiver unit 124. The battery 140 within the receiver unit 124 may be utilized to supply electrical energy to the various components involved in generating and transmitting the RF signal. The battery 140 may be designed to store electrical energy and supply it to the respective components as required. The battery 140 may be rechargeable or replaceable cells capable of providing DC voltage. They are selected based on factors such as voltage output and capacity, which may be measured in ampere-hours, Ah, and size to meet the power requirements of each component effectively. In the receiver unit 124, batteries 140 may provide electrical energy to receive and process RF signals detected by the receiver antenna 126. The battery 140 may power components such as amplifiers 138, filters, and signal processing circuitry, enabling the device to analyze incoming RF signals and extract relevant information. In some embodiments, the battery 140 used may include lithium-ion, nickel-metal hydride, or other types suitable for portable electronic devices.

Further, embodiments may include a directional shield 142, which may be a physical barrier or enclosure designed to direct or block electromagnetic radiation in a specific direction. The directional shield 142 may be constructed from conductive materials such as metal to attenuate RF signals, thereby controlling the propagation of electromagnetic waves. The directional shield 142 may be positioned around the RF oscillator 110 and transmitter antenna 120 components and may act as a physical barrier that prevents RF signals from propagating in undesired directions, thereby enhancing the precision and accuracy of signal transmission and reception. During operation, when the transmitter unit 106 generates an RF signal, the directional shield 142 helps to focus and channel this signal towards the intended detection area. By reducing signal dispersion, the directional shield 142 improves the efficiency of signal transmission and enhances the system's overall sensitivity to detecting RF responses from underground objects or materials.

Further, embodiments may include a power supply 144, such as batteries serving as the power source for specific components within the RF detection device 102, including the control panel 146. This power supply 144 may be designed to store electrical energy and supply it to the respective components as required. The power supply 144 for the control panel 146 may be rechargeable or replaceable cells capable of providing DC voltage. The power supply 144 may be selected based on factors such as voltage output and capacity, which may be measured in ampere-hours, Ah, and size to meet the power requirements of each component effectively. In some embodiments, the control panel 146 may rely on the power supply 144 to maintain functionality for user interface operations, data processing, and communication with other parts of the RF detection device 102. The power supply 144 in the control panel 146 may ensure that it remains operational during field use, supporting tasks such as signal monitoring, parameter adjustment, and data transmission. In some embodiments, the power supply 144 used in these components may include lithium-ion, nickel-metal hydride, or other types suitable for portable electronic devices. The power supply 144 may be integrated into the design to provide sufficient power capacity and longevity, allowing the RF detection device 102 to operate autonomously for extended periods between recharges or replacements.

Further, embodiments may include a control panel 146, which may be a centralized interface comprising electronic controls and displays. The control panel 146 may serve as the user-accessible interface for configuring, monitoring, and managing the RF detection device's 102 operational parameters and data output. In some embodiments, the control panel 146 may be designed to provide operators with intuitive access to control and monitor various aspects of the RF detection device 102. The control panel 146 may allow for the configuration of settings such as signal frequency, transmission power, receiver sensitivity, and signal processing algorithms. In some embodiments, operators may use the control panel 146 to initiate and terminate detection operations, adjust calibration settings, and troubleshoot operational issues. In some embodiments, the control panel 146 may include a graphical display screen or LED indicators to present real-time status information and measurement results. In some embodiments, input controls such as buttons, knobs, or touch-sensitive panels may enable operators to interact with the device, input commands, and navigate through menu options. The control panel 146 may interface directly with the internal electronics of the RF detection device 102, including the transmitter unit 106, receiver unit 124, transmitter antenna 120, receiver antenna 126, and signal processing circuitry. Through electronic connections and communication protocols, the control panel 146 may send commands to adjust operational parameters and receive feedback and status updates from the RF detection device 102. In some embodiments, the control panel 146 may be mounted on the support frame 104 and may provide an operator with control of the RF detection device 102, including adjusting various settings and signaling the operator of a detected material. In some embodiments, a rechargeable power supply 144 may power the RF detection device 102, including the transmitter unit 106, the receiver unit 124, and the control panel 146. In some embodiments, multiple batteries may be used. In some embodiments, a tone generator 136, such as a speaker, may be mounted to the support frame 104 to provide audible signals to the operator for detecting target materials.

Further, embodiments may include a communication interface 148, which may be a hardware and software solution that enables data exchange between different systems or components within a network. The communication interface 148 may act as a bridge, facilitating the transfer of information by converting data into a format that can be transmitted and received by different devices. In some embodiments, the communication interface 148 may support various protocols and standards, such as Ethernet, Wi-Fi, Bluetooth, USB, and others, depending on the application requirements. For example, an Ethernet interface may be used for wired network connections, providing reliable and high-speed data transfer. In some embodiments, a Wi-Fi interface may enable wireless connectivity, allowing the device to communicate with remote servers, mobile devices, or cloud-based applications without physical cables. In some embodiments, Bluetooth and USB interfaces may also be included for short-range wireless communication and direct data transfer, respectively. The communication interface 148 may transmit the processed data from the DSP to external systems for further analysis, reporting, or storage. After the DSP processes the signals received from the ADC and extracts meaningful information about the target materials, the control panel 146 may package this data into suitable formats, such as JSON or XML. The communication interface 148 may then send this data over the network to a remote server or database, where it can be accessed by operators, analysts, or automated systems for further decision-making. In some embodiments, the communication interface 148 may provide remote monitoring and control of the RF detection device 102. Operators may use a web-based interface or a mobile application to access real-time status updates, view detection logs, and adjust configuration settings. For example, if the RF detection device 102 needs to be calibrated for a new target material, the configuration updates can be sent remotely through the communication interface, minimizing the need for on-site adjustments. In some embodiments, the communication interface 148 may support alerting and notification functionalities. When the control panel 146 detects the presence of hazardous materials, it can use the communication interface 148 to send immediate alerts to designated personnel via email, SMS, or push notifications.

Further, embodiments may include a detection module 150, which is initiated upon the RF detection device 102 powering up, including the transmitter unit 106 and receiver unit 124. The control panel 146 runs diagnostics and configures the devices to detect specific materials. Frequencies are selected based on the atomic structure of the target elements or compounds. The transmitter unit 106 generates and transmits an RF signal, which interacts with the environment and target materials. The receiver unit 124 captures and processes the altered signal, indicating the presence of the target material. The detection data, including material detected, signal strength, and frequency, are stored in the detection database 154, and the detection module 150 initiates the transfer module 152.

Further, embodiments may include a transfer module 152, which may be initiated by the detection module 150 and connects to the detection network 160 and extracts data from the detection database 154. The transfer module 152 sends this extracted data to the data collection module 164 before returning to the detection module 150.

Further, embodiments may include a detection database 154, which may contain the data collected by the RF detection device 102. The detection database 154 may contain the device ID, the GPS location of the device, the timestamp of the detection, and the target material detected. In some embodiments, the device ID may identify the specific RF detection device sending the information. In some embodiments, the GPS location may be the coordinates the device is positioned and the direction in which the device is detecting. In some embodiments, the timestamp may indicate the exact time at which the detection occurred. In some embodiments, the target material detected may be the specific material or substance the device has identified, such as a specific element like uranium or a compound such as gunpowder or explosives. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system 100 to differentiate between various substances and determine their presence with high accuracy. In some embodiments, the detection database 154 may include environmental conditions, such as temperature, humidity, and atmospheric pressure, which may affect RF signal propagation and detection accuracy.

Further, embodiments may include a specific material database 156, which may store and manage detailed information about various target materials. The specific material database 156 may be used to configure the detection parameters to identify specific materials based on their unique electromagnetic properties. Each entry in the database may be defined by the material's atomic structure, which includes the total number of protons and neutrons. The unique nuclear composition allows each substance to be distinctly identifiable and detectable through its resonant frequency. The specific material database 156 may contain a unique material ID, the common name of the material, the number of protons, the number of neutrons, and the atomic mass, which is the sum of protons and neutrons. The specific material database 156 may also contain calculated resonant frequencies based on the atomic characteristics. The resonant frequencies are critical for configuring the transmitter unit of the RF detection device 102, which sends out signals at these specific frequencies to induce a resonant response in the target material. For example, the specific material database 156 may contain an entry for Arsenic (As) with 33 protons and 42 neutrons, resulting in an atomic mass of 75. The resonant frequencies for Arsenic could be 33 Hz, based on the number of protons, 42 Hz, based on the number of neutrons, and 75 Hz, based on the atomic mass. These frequencies may also be increased by orders of magnitude, such as 10× or 100×, to suit different detection environments. In some embodiments, for compounds, the specific material database 156 calculates a combined frequency based on the sum of the resonant frequencies of the constituent elements. For example, a formaldehyde molecule composed of 16 protons and 14 neutrons with a total atomic mass of 30 would have corresponding frequencies of 16 Hz, 14 Hz, and 30 Hz, respectively. Another example may be smokeless gunpowder, specifically nitroglycerin, with the chemical composition CH2NO3CHNO3CH2NO3. The frequency for this compound may be calculated by summing the frequencies based on the atomic numbers of its constituent elements: 6 carbon+1×2 hydrogen+7 nitrogen+8×3 oxygen, repeated thrice, resulting in a total of 116 protons. This is then multiplied by 10 to yield a base frequency of 1160 Hz for detection purposes. In some embodiments, the specific material database 156 may account for overlapping frequencies among different elements and compounds. To enhance the accuracy of detection, the system 100 may employ multiple methods to calculate and verify the target material's frequency, such as using combinations of proton counts, neutron counts, and atomic masses, which allows the system 100 to distinguish between materials with similar frequencies by leveraging the unique resonant properties of each substance.

Further, embodiments may include a cloud 158, or communication network, which may be a wired and/or wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on the sharing of resources to achieve coherence and economies of scale, like a public utility, while third-party clouds 158 enable organizations to focus on their core businesses instead of expending resources on computer infrastructure and maintenance.

Further, embodiments may include a detection network 160, which may be a collection of interconnected devices that communicate with each other to share resources, data, and applications. In some embodiments, the detection network 160 may utilize various protocols, such as TCP/IP, to ensure data is transmitted accurately and efficiently. In some embodiments, the detection network 160 may transmit the processed data from the DSP to user devices 176, allowing operators to view and analyze the data collected. The detection network 160 may be designed to support real-time data transmission, remote monitoring, and analysis functionalities, ensuring that the system 100 operates efficiently and effectively. Upon receiving the processed signals from the DSP, the control panel 146 may package the data into standardized formats such as JSON or XML, making it suitable for transmission over the detection network 160. In some embodiments, the detection network 160 setup may involve an Ethernet or Wi-Fi interface integrated into the control panel 146, which establishes a connection to the local network or the internet. For example, when the control panel 146 detects the presence of target materials, it sends the relevant data to the server or cloud platform via the detection network 160. The data is then processed and stored, allowing operators to access it through their user devices. For example, if the RF detection device 102 identifies a hazardous material, the data is immediately transmitted to the cloud platform, where it triggers alerts and notifications to the operators'devices. Operators can then log into the platform, view detailed reports, and analyze the data to make informed decisions.

Further, embodiments may include a base module 162, which may initiate the data collection module 164, the ID module 166, and the report module 168.

Further, embodiments may include a data collection module 164, which begins by being initiated by the base module 162. The data collection module 164 connects to the RF detection device 102 and continuously polls for the detection data from the RF detection device 102. The data collection module 164 receives the detection data from the transfer module 152 and stores the detection data in the target database 172. The data collection module 164 returns to the base module 162.

Further, embodiments may include an ID module 166, which may be initiated by the base module 162. The ID module 166 extracts the first entry from the target database 172 to check if a device detected a target material. If so, the ID module 166 extracts the device ID and compares it with the perimeter database 170 to find a partner device ID. The ID module 166 then filters the target database 172 using this partner device ID to see if the partner device also detected the target material. If the partner device detected the material, the ID module 166 stores that the material is within the perimeter in the report database 174. If the partner device did not detect the material, the ID module 166 stores that the material is outside the perimeter in the report database 174. If no target material is detected or after storing the data, the ID module 166 checks for more entries in the target database 172. If more entries are found, it repeats the process with the next entry. If no more entries are left, the ID module 166 returns to the base module 162.

Further, embodiments may include a report module 168, which may begin by being initiated by the base module 162. The report module 168 filters the report database 172 on the in-perimeter target materials. The report module 168 extracts the data from the report database 172. The report module 168 connects to the user device 176. The report module 168 sends a notification to the user device 176 with the extracted data from the report database 172. The report module 168 returns to the base module 162.

Further, embodiments may include a perimeter database 170, which may contain the pairs or combinations of RF detection devices 102 that are positioned to detect an area between one another, for example, if a first device is positioned to detect target materials in a north direction a second device may be positioned north of the first device and positioned to detect target materials south direction. The RF detection devices 102 work together to detect specific target materials within the perimeter. The perimeter database 170 may contain a perimeter ID, a first RF device ID, and a second RF device ID. In some embodiments, the perimeter ID may be a unique identifier for each perimeter setup, used to reference and manage the perimeter as a distinct unit within the system 100. In some embodiments, the first RF device ID may be a unique identifier of the first RF device in the pair, responsible for detecting the presence of a target material and initiating the verification process. In some embodiments, the second RF device ID may be a unique identifier of the second RF device in the pair, which corroborates the detection of the target material by the first device. In some embodiments, the RF detection devices 102 may be set up in various configurations, such as in a straight line or positioned to look at one another, in a triangle, square, circle, etc. In some embodiments, the directional shield 142 of the RF detection devices may allow for a larger viewing angle to allow for a wider detection area. In some embodiments, the perimeter database 170 data entries may be pre-calibrated or calibrated by operators on the network. In some embodiments, the calibration may involve setting up the RF detection devices 102 at specific locations and ensuring they are properly aligned to monitor the designated perimeter area effectively. When the first RF detection device 102 detects a target material, it signals the system 100 to query the paired second RF detection device 102. The second RF detection device 102, checks for the presence of the same target material. If the second device also detects the target material, the system 100 concludes that the material is within the perimeter. If the second device does not detect the material, the system 100 concludes that the material is outside the perimeter. In some embodiments, the detection results are stored for further analysis and reporting. In some embodiments, the RF detection devices 102 may be equipped with a GPS or global positioning system 100, and when the detection network 160 receives the data from the RF detection device 102, it may also receive the device's location.

Further, embodiments may include a target database 172, which may be created in the process described in the data collection module 164, which collects the detection data from a plurality of RF detection devices 102, and the data may be analyzed in the process described in the ID module 166 which determines if the detected target material is within the perimeter. The target database 172 may contain the device ID, the timestamp the data was collected was by the RF detection device 102, the target material, and whether the target material was detected or not. In some embodiments, the target database 172 may contain the GPS location of each of the RF detection devices 102. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system 100 to differentiate between various substances and determine their presence with high accuracy. In some embodiments, the target database 172 may include environmental conditions, such as temperature, humidity, and atmospheric pressure, which may affect RF signal propagation and detection accuracy.

Further, embodiments may include a report database 174, which may be created in the process described in the ID module 166, which stores the results of whether a target material is within or outside the perimeter and is used in the report module 168 to notify or inform a user or operator. The report database 174 may include a report ID, a first RF device ID, a second RF device ID, a timestamp, the target material, and the location relative to the perimeter. In some embodiments, the report ID may be a unique identifier for each report entry, which allows for easy referencing and management of individual detection events. In some embodiments, the first device ID may be the unique identifier of the first RF device involved in the detection event. In some embodiments, the second device ID may be the unique identifier of the second RF device involved in the detection event. In some embodiments, the timestamp may be the exact date and time when the detection event occurred, providing a temporal context for the detection results. In some embodiments, the target material may be the specific material that was detected, such as an explosive, chemical agent, or biological agent. In some embodiments, the perimeter result may indicate whether the detected target material is inside or outside the perimeter based on the combined detections of the first and second RF devices. For example, the ID module 166 begins by extracting the first entry from the target database 172 to check if an RF detection device 102 has detected a target material. The ID module 166 finds that the first RF detection device 102 has detected the target material, such as uranium, and the entry shows “yes.” The ID module 166 may then check the corresponding second RF detection device 102 to verify if it also detected the same material. If both devices have detected the target material, the ID module 166 determines that the material is inside the perimeter. The ID module 166 creates a new entry in the report database 174 with the detection data. In some embodiments, the report database 174 may be used by military bases to monitor entrances and sensitive areas to prevent unauthorized materials, such as explosives, chemical agents, and biohazardous substances, from entering the perimeter. In some embodiments, the report database 174 may be used by airports to enhance security by screening for explosives, narcotics, and biohazardous materials and the system 100 may be located at various checkpoints, including entry gates and luggage handling areas. In some embodiments, the report database 174 may be used in the medical field for cancer detection by identifying cancerous tissues non-invasively by detecting specific biomarkers or cancer cells through RF signals.

Further, embodiments may include a user device 176, which may be an electronic device that provides an interface for users to interact with applications, data, and other digital services. In some embodiments, user devices 176 may include desktop computers, laptops, tablets, and smartphones to specialized equipment like industrial handhelds or medical diagnostic tools. In some embodiments, the user device 176 may include input mechanisms, such as keyboards, touchscreens, etc., and output displays, such as screens, processing capabilities, storage, and connectivity options. The user device 176 may enable operators to view and analyze the data collected by the detection network 160. In some embodiments, the user device 176 may act as an interface through which operators receive real-time updates, visualize data, and make informed decisions based on the detected signals. In some embodiments, the user device 176 may connect to the detection network 160, where the RF detection data is stored and processed. For example, the RF detection devices 102 may identify the presence of hazardous materials, and the processed data from the DSP may be transmitted over the detection network 160 to the user device 176, which may be equipped with specialized application software or a web-based interface designed to display the data in a user-friendly and comprehensible format. In some embodiments, the user device 176 may include a high-resolution display screen that presents data visualizations, such as graphs, charts, and maps, allowing operators to quickly interpret the detection results. In some embodiments, the user device 176 may include various connectivity options, such as Wi-Fi, Ethernet, Bluetooth, and cellular networks, to ensure reliable communication with the RF detection devices 102, detection network 160, and remote servers. In some embodiments, the user device 176 may include interactive dashboards, customizable alerts, and detailed logs of detection events. For example, an operator may use the interface to set thresholds for alerts, view historical data trends, and configure the detection parameters remotely.

Further, embodiments may include 3rd party detection devices 178 which may connect to the detection network 160 and send collected data, with a timestamp, to further enhance the analysis performed by the detection network 160 to validate the identification of a target material. The 3rd party detection devices 178 may include metal detectors, X-ray scanners, chemical sensors, radiation detectors, thermal cameras, biometric scanners, acoustic sensors, explosive trace detectors, environmental sensors, UV and IR sensors, etc. In some embodiments, the detection data sent by the 3rd party detection devices 178 may also include GPS positioning data. In yet another embodiment, a near-field material detection system uses a magnetic-based loop antenna that focuses on magnetic field interaction within close proximity to the target material. This system uses magnetic resonance principles, detecting changes in the magnetic field due to interactions with materials possessing magnetic susceptibility, such as ferromagnetic metals. The loop antenna generates a localized oscillating magnetic field, and when materials are introduced into the detection zone, they alter the field by inducing eddy currents or magnetic resonance effects. These changes are then measured to determine the material's properties. This method is particularly useful in applications such as industrial quality control or close-range security screening, where detecting the magnetic characteristics of a material offers clear advantages.

In still another embodiment, far-field magnetic resonance techniques are employed for material detection at greater distances. This system 100 operates by transmitting an electromagnetic wave where the magnetic field component is emphasized, focusing on its interaction with materials that have resonant magnetic properties. By tuning the system 100 to specific resonant frequencies, materials that exhibit strong magnetic responses, such as certain alloys or ferromagnetic materials, can be detected over a larger range. The detection system then analyzes the phase or amplitude of the reflected wave to infer material characteristics. This embodiment is particularly suitable for remote sensing applications, such as geological surveys, where materials can be identified based on their magnetic resonance even when located at a distance from the detection apparatus.

In other embodiments, an array of antennas is used to simultaneously detect materials based on both RF and magnetic field interactions. The antenna array consists of dipole antennas optimized for detecting the electric component of the RF wave and loop antennas that focus on the magnetic field interaction. These two types of signals are combined to create a composite material signature, allowing for detailed analysis of both the dielectric and magnetic properties of the material. By processing both electric and magnetic field data, the system can more accurately identify materials that exhibit a combination of electrical conductivity and magnetic permeability, such as advanced composites or stealth materials. This dual-mode system can be particularly useful in defense or aerospace applications.

In still other embodiments, a magnetic-based antenna system is designed for material detection in environments where RF signals would typically be degraded, such as underground or underwater. This system uses a loop antenna to generate a magnetic field that interacts with materials possessing strong magnetic properties, even in situations where RF signals are heavily attenuated. The antenna detects variations in the magnetic field caused by materials with high permeability, such as iron or nickel-based substances. This method allows for the detection of magnetic materials in conditions where RF detection would be unreliable, such as in deep-sea exploration or subterranean mining operations, where conventional RF signals would fail to penetrate effectively.

In further embodiments, a phased array system is designed specifically to manipulate the magnetic component of the electromagnetic wave for high-resolution material detection. A phased array of loop antennas is used to steer and focus the magnetic field, creating a directed magnetic beam that can scan across a target area. The system detects materials based on how they alter the magnetic field, allowing for precise location and identification of magnetic objects. By adjusting the phase and amplitude of each antenna element, the system provides a fine degree of control, enabling highly localized material detection. This approach is useful in situations requiring detailed spatial resolution, such as identifying hidden metallic objects in security screening or detailed inspections in industrial settings.

In additional embodiments, a portable or wearable material detection system is implemented using a small, magnetic-based loop antenna for detecting magnetic materials in close proximity. This compact system allows security personnel or industrial workers to move through different environments while continuously monitoring for materials that exhibit magnetic properties. The loop antenna generates a localized magnetic field and detects perturbations caused by nearby magnetic materials, such as concealed weapons or magnetic tags. The system then alerts the user when such materials are detected, making it ideal for field operations where mobility and ease of use are critical.

In yet another embodiment, the material detection system is entirely RF-based, using a highly optimized RF antenna to detect materials based solely on their interaction with the RF field. The RF antenna transmits electromagnetic waves at specific frequencies, and the system analyzes how these waves are reflected, absorbed, or scattered by the material. By focusing on the dielectric constant or conductive properties of the target material, the system can accurately identify substances such as explosives, chemicals, or other dielectric materials. This approach is particularly effective in environments where magnetic field-based detection is unnecessary or less effective. The RF-based system can be adapted for wide-ranging applications, from industrial material testing to security scanning, where detecting the electrical characteristics of the material is sufficient for identification.

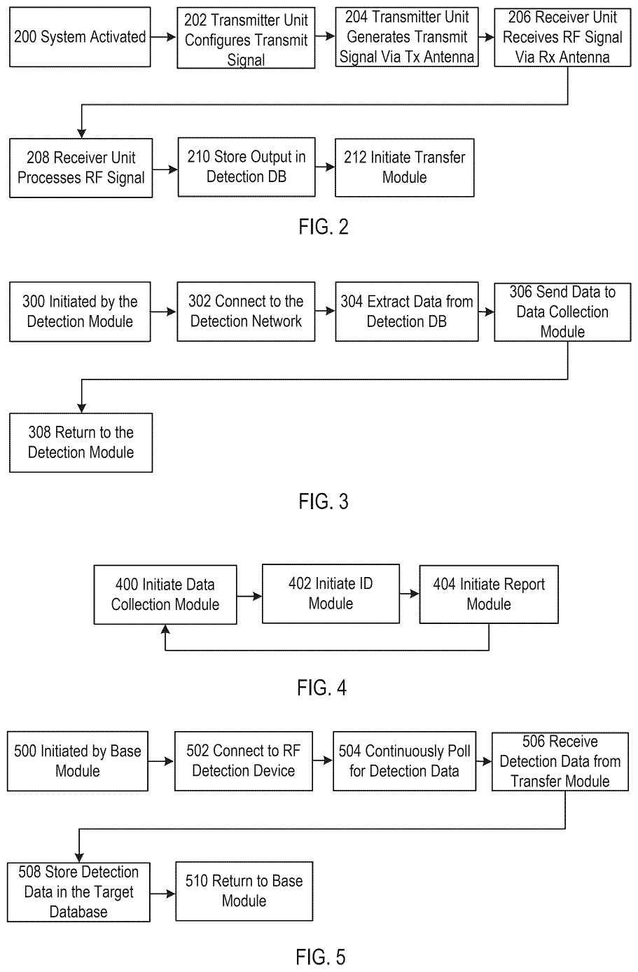

FIG. 2 is a flow chart of a method performed by the detection module 150. The process begins with the RF detection device 102 being activated, at step 200. The process begins with the activation of the power supply 144. In some embodiments, batteries in the transmitter unit 106, receiver unit 124, and control panel 146 may provide electrical energy. When the power switch is turned on, the power supply 144 distributes power to all subsystems, ensuring that each component receives the correct voltage and current levels required for operation. In some embodiments, the control panel 146 may begin a boot-up sequence, running diagnostics to check the status of each subsystem and may communicate with the transmitter unit 106 and receiver unit 124, sending initialization commands to configure their operating parameters. In some embodiments, status indicators on the control panel 146 may display the progress of the initialization process, showing a green LED to indicate successful power-up and system readiness. The control panel 146 may load the predefined detection configurations, ensuring the system is set to detect specific desired materials accurately. In some embodiments, a frequency for transmission is selected for a particular element based on the number of protons, number of neutrons, and/or atomic mass, such as the sum of protons and neutrons, for the element. For example, the selected frequencies for Arsenic (As) would be 33 Hz, based on the number of protons, 42 Hz, based on the number of neutrons, and 75 Hz, based on atomic mass. These frequencies can also be increased by one or more orders of magnitude, such as 10×, 100×, etc. Similarly, the frequencies for a compound can be selected based on the sum total of the constituent parts. For example, a formaldehyde molecule has a combined total of 16 protons, corresponding to a frequency of 16 Hz, 14 neutrons, corresponding to a frequency of 14 Hz, and a mass of 30, corresponding to a frequency of 30 Hz. Individual scans using two or more of these frequencies can be used to uniquely identify the element or compound. In some embodiments, a frequency is selected for a particular element based on the sum of the number of protons and atomic mass, such as the sum of protons and neutrons, for the element. For example, the selected frequency for Arsenic (As) would be 108 Hz based on the addition of 33 protons, with 75 atomic mass. This frequency can also be increased by one or more orders of magnitude, such as 10×, 100×, etc. Similarly, the frequency for a compound can be selected based on the sum total of the constituent parts. For example, a formaldehyde molecule has a combined total of 16 protons and a mass of 30. The corresponding frequency would be 46 Hz, addition of 16 protons with 30 mass. As another example, smokeless gunpowder would yield a base transmit frequency of 1160. The tuning frequency of 1160 Hz is derived from the chemical composition, discrete atomic structure, CH2NO3CHNO3CH2NO3 for nitroglycerin. By using the atomic number, or the number of protons for each element, the frequency is calculated as 6+(1*2)+7+(8*3)+6+1+7+(8*3)+6+(1*2)+7+(8*3) which yields a sum of 116 protons in the compound. This is then increased by an order of magnitude, such as 10×, yielding 1160 Hz as the frequency to search for nitroglycerin. In some embodiments, some elements and compounds may have overlapping frequencies using only one of the methods described above, and it may be beneficial to use multiple of the above-described methods when searching for or identifying a target material. The detection module 150 commands the transmitter unit 106 to configure, at step 202, the transmit signal. The transmitter unit 106 prepares the signal that will be transmitted for the purpose of detecting a target material. In some embodiments, the parameters and components may be set up with the desired characteristics to generate the RF signal. The control panel 146 determines the specific parameters of the RF signal that need to be generated. The parameters may include the frequency, amplitude, and modulation type required to effectively detect the target materials. Once the parameters are set, the control panel 146 sends a command to activate the oscillator circuit within the transmitter unit 106. The oscillator circuit may be responsible for generating a stable RF signal at the desired frequency and may consist of components like capacitors, inductors, and amplifiers that work together to create the oscillating signal. The power delivery to the oscillator circuit may be managed by the SCR 114. When the control panel 146 sends a gate signal to the SCR 114, it switches from a non-conductive to a conductive state, allowing current from the power source, such as batteries, to flow to the oscillator circuit. After the oscillator circuit generates the RF signal, the transformer 116 adjusts the voltage level of the signal to match the requirements of the transmit antenna 120. It may also provide impedance matching to ensure efficient signal transmission. The transformer 116 ensures that the RF signal is at the appropriate voltage and current levels for optimal transmission. For example, the control panel 146 may determine that an RF signal with a frequency of 50 Hz is required to detect a specific material. It sends a command to the transmitter unit 106 to configure this signal. The oscillator circuit is activated, generating an RF signal at 50 Hz. The SCR 114 is triggered, allowing power from the batteries to flow to the oscillator circuit. The generated signal is then conditioned by the transformer 116, ensuring it is at the correct voltage level for transmission. The detection module 150 commands transmitter unit 106 to generate, at step 204, the transmit signal via the transmit antenna 120. The transmitter unit 106 generates the RF signal and transmits it through the transmit antenna 120 by converting electrical energy into radio waves that can be used for detecting specific materials. The transmit antenna 120 radiates the RF signal into the environment. The radio waves propagate through the medium, such as air or ground, and interact with the target materials. The interaction between the RF signal and the target materials will produce detectable changes in the signal, which can be received and analyzed by the receiver unit 124. For example, the transmitter unit 106 generates a wave pulse at a specified frequency that is transmitted directionally into the ground. The generated frequency is closely approximate or exact to that of the target material, and that relationship creates a responsive RF wave and/or a magnetic line between the transmitter antenna 120 and the target. When the RF detection device 102 is aligned with a target material, for example, when the opening of the directional shield 142 is pointing toward the target material, the voltage produced by the receiver antenna 126 changes and thereby produces a detection output signal, such as an audio signal having a tone different than that of the baseline. A reflective wave is produced by the target material that amplifies, resonates, offsets, or otherwise modifies the magnetic field passing through the receiver antenna 126 to alter the voltage produced, thereby generating the output signal. The receiver antenna 126 is responding to a voltage increase from the transmitter antenna 120 swinging over the magnetic line to the material. The detection module 150 commands the receiver unit 124 to receive, at step 206, the RF signal via receiver antenna 126. The receiver unit 124 captures the RF signal that has interacted with the environment and potential target materials using the receiver antenna 126. The receiver antenna 126 captures the incoming RF signal, which has been transmitted by the transmitter unit 106 and has interacted with the environment and any target materials present. The receiver antenna 126 may be designed to effectively capture these radio waves and convert them back into electrical signals. Once the RF signal is received by the receiver antenna 126, it may be fed into an RF amplifier, which boosts the signal strength without significantly altering its characteristics. In some embodiments, the use of the standard atomic structure of a material may be used to calculate the resonant frequency to which a particular substance would generate or respond. Each element and compound includes a definable atomic structure composed of the total number of protons and neutrons of that target material. This unique nuclear composition of every substance makes it uniquely identifiable and detectable. The manner in which this information is applied thus enables the detection of any target substance. A target material can be detected and located based on a resonant, responsive RF wave and/or magnetic relationship between the target and a transmitter antenna 120 transmitting at the frequency specific and unique to the target material. The transmitter unit 106, through the transmitter antenna 120, induces a resonance due to responsive RF waves and/or magnetic and/or otherwise in a targeted material to resonate at a specific computed frequency. The receiver antenna 126 and receiver circuit 128 detect the resonance induced in the material and, in so doing, indicate the approximate line of bearing to the material. The primary method used by this detection system to detect specific materials is based on tuning the circuit 108 of the transmitter unit 106 to a specific value that is computed for the material of interest. The frequency can be based on any of the three defining characteristics of the substance, the number of protons, the number of neutrons, or the atomic mass, such as the sum of protons and neutrons and combinations thereof. The frequency can be transmitted at varying voltages to compensate for other external effects or interference. In some embodiments, a table or database of characteristics of common materials may be used to calculate the resonant frequencies. To accomplish this tuning, the frequency of the signal from the transmitter antenna 120 is set to some harmonic of the elements of the material. The detection module 150 commands the receiver unit 124 to process, at step 208, the RF signal. The receiver unit 124 processes the received RF signal to extract meaningful data that can be analyzed for the presence of specific materials, which may involve further amplification, filtering, digitization, and initial data processing before the signal is sent to the control panel 146 for detailed analysis. In some embodiments, after the RF signal is received and initially amplified, it may require further amplification to ensure the signal is at an optimal level for processing. In some embodiments, an additional RF amplifier within the receiver unit 124 may boost the signal strength while maintaining its integrity. The amplified signal may be subjected to more advanced filtering by the filter circuit, which removes any residual noise and unwanted frequencies that might have passed through the initial filtering stage. In some embodiments, the filtering may involve bandpass filters that allow only the desired frequency range to pass through. The filtered analog signal may be converted into a digital format using an Analog-to-Digital Converter, ADC. The ADC samples the analog signal at a high rate and converts it into a series of digital values. The digitized signal may be processed using digital techniques. The digital signal may be fed into a Digital Signal Processor, DSP, within the receiver unit 124. In some embodiments, the DSP may perform initial data processing tasks such as demodulation, noise reduction, and feature extraction. Demodulation involves extracting the original information-bearing signal from the carrier wave. Noise reduction techniques may further clean the signal, making it easier to analyze. Feature extraction may involve identifying key characteristics of the signal that are indicative of the presence of target materials. The detection module 150 stores, at step 210, the output in the detection database 154. The detection database 154 may contain the data collected by the RF detection device 102. The detection database 154 may contain the device ID, the GPS location of the device, the timestamp of the detection, and the target material detected. In some embodiments, the device ID may identify the specific RF detection device sending the information. In some embodiments, the GPS location may be the coordinates the device is positioned and the direction in which the device is detecting. In some embodiments, the timestamp may indicate the exact time at which the detection occurred. In some embodiments, the target material detected may be the specific material or substance the device has identified, such as a specific element like uranium or a compound such as gunpowder or explosives. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the detection database 154 may include environmental conditions, such as temperature, humidity, and atmospheric pressure, which may affect RF signal propagation and detection accuracy. The detection module 150 initiates, at step 212, the transfer module 152. The transfer module 152 may be initiated by the detection module 150. It then connects to the detection network 160 and extracts data from the detection database 154. The transfer module 152 sends this extracted data to the data collection module 164 before returning to the detection module 150.

FIG. 3 is a flow chart of a method performed by the transfer module 152. The process begins with the transfer module 152 being initiated, at step 300, by the detection module 150. In some embodiments, the transfer module 152 may continuously query the detection database 154 for a new data entry, and once a new data entry is stored, the transfer module 152 connects to the detection network 160 to send the newly added detection data. The transfer module 152 connects, at step 302, to the detection network 160. The transfer module 152 may connect to the detection network 160 through the communication interface 148 and the cloud 158. The transfer module 152 extracts, at step 304, the data from the detection database 154. The transfer module 152 may extract the data, such as the device ID, the GPS location of the device, the timestamp of the detection, and the target material detected. The transfer module 152 sends, at step 306, the extracted data from the detection database 154 to the data collection module 164. The transfer module 152 may send or transmit the data that was extracted from the detection database 154 to the data collection module 164. The data may include the device ID, the GPS location of the device, the timestamp of the detection, and the target material detected. In some embodiments, the data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the data may include environmental conditions, such as temperature, humidity, and atmospheric pressure, which may affect RF signal propagation and detection accuracy. The transfer module 152 returns, at step 308, to the detection module 150.

FIG. 4 is a flow chart of a method performed by the base module 162. The process begins with the base module 162 initiating, at step 400, the data collection module 164. The data collection module 164 begins by being initiated by the base module 162. The data collection module 164 connects to the RF detection device 102 and continuously polls for the detection data from the RF detection device 102. The data collection module 164 receives the detection data from the transfer module 152 and stores the detection data in the target database 172. The data collection module 164 returns to the base module 162. The base module 162 initiates, at step 402, the ID module 166. The ID module 166 may be initiated by the base module 162. The ID module 166 extracts the first entry from the target database 172 to check if a device detected a target material. If so, the ID module 166 extracts the device ID and compares it with the perimeter database 170 to find a partner device ID. The ID module 166 then filters the target database 172 using this partner device ID to see if the partner device also detected the target material. If the partner device detected the material, the ID module 166 stores that the material is within the perimeter in the report database 174. If the partner device did not detect the material, the ID module 166 stores that the material is outside the perimeter in the report database 174. If no target material is detected or after storing the data, the ID module 166 checks for more entries in the target database 172. If more entries are found, it repeats the process with the next entry. If no more entries are left, the ID module 166 returns to the base module 162. The base module 162 initiates, at step 404, the report module 168. The report module 168 begins by being initiated by the base module 162. The report module 168 filters the report database 172 on the in-perimeter target materials. The report module 168 extracts the data from the report database 172. The report module 168 connects to the user device 176. The report module 168 sends a notification to the user device 176 with the extracted data from the report database 172. The report module 168 returns to the base module 162.

FIG. 5 is a flow chart of a method performed by the data collection module 164. The process begins with the data collection module 164 being initiated, at step 500, by the base module 162. In some embodiments, the data collection module 164 may be continuously initiated to connect to a plurality of RF detection devices 102 to receive and store the detection data. The data collection module 164 connects, at step 502, to the RF detection device 102. The data collection module 164 may connect to the RF detection device 102 via the cloud 158. In some embodiments, the data collection module 164 may connect to a plurality of RF detection devices 102 to receive detection data from devices located around or within a perimeter. In some embodiments, the detection network 160 may include security protocols or measures to ensure that only trusted devices can connect. The data collection module 164 continuously polls, at step 504, for the detection data from the RF detection device 102. The data collection continuously polls to receive the device ID, GPS location, timestamp, and target material from the RF detection device 102. The data collection module 164 receives, at step 506, the detection data from the transfer module 152. The detection data may include the device ID, the GPS location of the device, the timestamp of the detection, and the target material detected. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the detection data may include environmental conditions, such as temperature, humidity, and atmospheric pressure, which may affect RF signal propagation and detection accuracy. The data collection module 164 stores, at step 508, the detection data in the target database 172. The target database 172 may contain the device ID, the timestamp the data was collected was by the RF detection device 102, the target material, and whether the target material was detected or not. In some embodiments, the target database 172 may contain the GPS location of each of the RF detection devices 102. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the target database 172 may include environmental conditions, such as temperature, humidity, and atmospheric pressure, which may affect RF signal propagation and detection accuracy. The data collection module 164 returns, at step 510, to the base module 162.

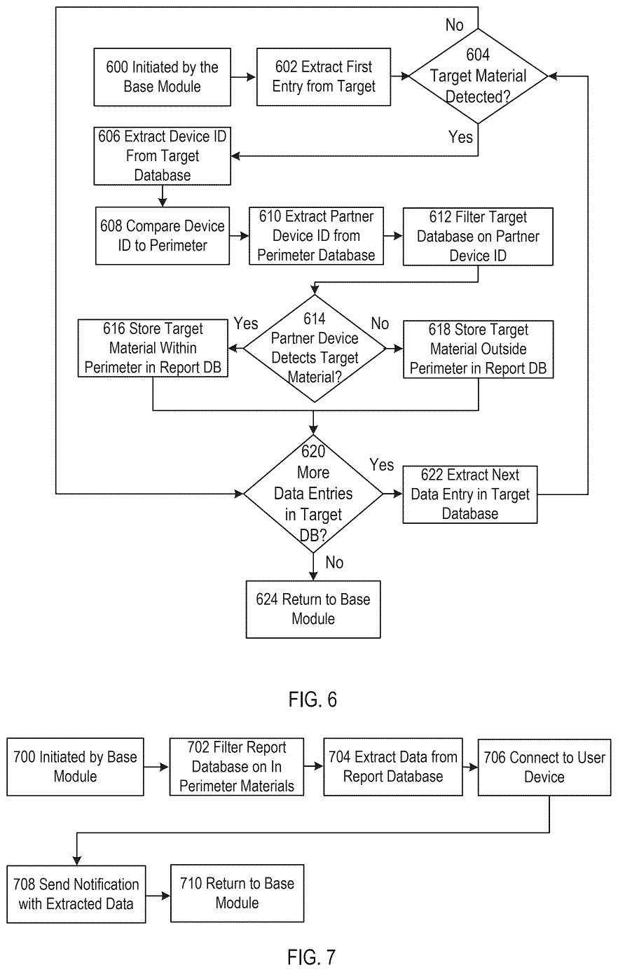

FIG. 6 is a flow chart of a method performed by the ID module 166. The process begins with the ID module 166 being initiated, at step 600, by the base module 162. In some embodiments, the ID module 166 may continuously query the target database 172 for a new data entry and be initiated once a new data entry is stored. The ID module 166 extracts, at step 602, the first entry from the target database 172. The target database 172 may contain the device ID, the timestamp the data was collected was by the RF detection device 102, the target material, and whether the target material was detected or not. In some embodiments, the target database 172 may contain the GPS location of each of the RF detection devices 102. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the target database 172 may include environmental conditions, such as temperature, humidity, and atmospheric pressure, which may affect RF signal propagation and detection accuracy. The ID module 166 determines, at step 604, if a device from the target database 172 data entry detected a target material. The ID module 166 may determine if the device detected a target material through the data entry, which may contain a yes or no value from the RF detection device 102 if the target material was detected. If the value is “yes,” the ID module 166 determines that the device has detected the target material. If the value is “no,” the ID module 166 concludes that the target material was not detected by the device. If it is determined that the device from the data entry in the target database 172 detected a target material, the ID module 166 extracts, at step 606, the device ID from the target database 172. The ID module 166 may extract the device ID which may be a unique identifier that is related to a specific RF detection device 102. The ID module 166 compares, at step 608, the extracted device ID to the perimeter database 170. The perimeter database 170 may contain the pairs or combinations of RF detection devices 102 that are positioned to detect an area between one another. For example, if a first device is positioned to detect target materials in a north direction, a second device may be positioned north of the first device and positioned to detect target materials south direction. The RF detection devices 102 work together to detect specific target materials within the perimeter. The perimeter database 170 may contain a perimeter ID, a first RF device ID, and a second RF device ID. In some embodiments, the perimeter ID may be a unique identifier for each perimeter setup, used to reference and manage the perimeter as a distinct unit within the system. In some embodiments, the first RF device ID may be a unique identifier of the first RF device in the pair, responsible for detecting the presence of a target material and initiating the verification process. In some embodiments, the second RF device ID may be a unique identifier of the second RF device in the pair, which corroborates the detection of the target material by the first device. In some embodiments, the RF detection devices 102 may be set up in various configurations, such as in a straight line or positioned to look at one another, in a triangle, square, circle, etc. In some embodiments, the directional shield 142 of the RF detection devices may allow for a larger viewing angle to allow for a wider detection area. In some embodiments, the perimeter database 170 data entries may be pre-calibrated or calibrated by operators on the network. In some embodiments, the calibration may involve setting up the RF detection devices 102 at specific locations and ensuring they are properly aligned to monitor the designated perimeter area effectively. When the first RF detection device 102 detects a target material, it signals the system to query the paired second RF detection device 102. The second RF detection device 102, checks for the presence of the same target material. If the second device also detects the target material, the system concludes that the material is within the perimeter. If the second device does not detect the material, the system concludes that the material is outside the perimeter. In some embodiments, the detection results are stored for further analysis and reporting. In some embodiments, the RF detection devices 102 may be equipped with a GPS or global positioning system, and when the detection network 160 receives the data from the RF detection device 102, it may also receive the device's location. The ID module 166 extracts, at step 610, the partner device ID from the perimeter database 170. The ID module 166 extracts the partnered or paired device ID of the first device that was determined to detect a target material. The ID module 166 filters, at step 612, the target database 172 on the partner device ID. The ID module 166 then uses the extracted partner device ID from the perimeter database 170 to filter the target database 172 on the partner device ID. In some embodiments, the ID module 166 may further filter the target database 172 on the timestamp to ensure that the data for both RF detection devices are from the same time. The ID module 166 determines, at step 614, if the partner device also detected a target material. The ID module 166 may determine if the partner device also detected a target material through the data entry, which may contain a yes or no value from the RF detection device 102 if the target material was detected. If the value is “yes,” the ID module 166 determines that the device has detected the target material. If the value is “no,” the ID module 166 concludes that the target material was not detected by the device. If it is determined that the partner device also detected a target material in the ID module 166 stores, at step 616, the target material is within the perimeter in the report database 174. In some embodiments, the ID module 166 may store both RF detection devices 102 IDs, the timestamp of the detection, the target material that was detected, and that the target material was within the perimeter. If it is determined that the partner device did not detect a target material, the ID module 166 stores, at step 618, the target material is outside of the perimeter in the report database 174. In some embodiments, the ID module 166 may store both RF detection devices 102 IDs, the timestamp of the detection, the target material that was detected, and that the target material was outside the perimeter. In some embodiments, when the material is detected by two RF detection devices 102 that both have a known location, the system may triangulate the location of the target material. For example, if the first RF detection device 102 is located on the northern edge of the monitored perimeter. When this first RF detection device 102 identifies a target material, the RF detection devices 102 along the eastern wall may be queried to determine if they detect the target material. By collecting detection responses and using the relative signal strength and time delay between the RF detection devices 102 to determine the intersection point, where the detected signal is strongest or most coherent across the RF detection devices 102, pinpointing the target material's location. In some embodiments, the RF detection devices 102 may use their GPS functionality to improve triangulation accuracy by adding positional data to each detecting device, creating a spatial map of the observed area. The system can then calculate where the signals converge, allowing it to identify a central point of detection within the perimeter. This triangulated location can be stored along with the timestamp, device IDs, and detection results in the report database 174. Additionally, the system could perform continuous triangulation in real-time to update the target material's location dynamically, which is especially useful for moving targets or dynamic perimeter boundaries. If it is determined that the device did not detect a target material or after the data is stored in the report database 174, the ID module 166 determines, at step 620, if there are more data entries remaining in the target database 172. If it is determined that there are more data entries remaining in the target database 172, the ID module 166 extracts, at step 622, the next data entry in the target database 172, and the process returns to determining if the device detected a target material. If it is determined that there are no more data entries remaining in the target database 172, the ID module 166 returns, at step 624, to the base module 162.

FIG. 7 illustrates is a flow chart of a method performed by report module 168. The process begins with the report module 168 being initiated, at step 700, by the base module 162. In some embodiments, the report module 168 may continuously query the report database 172, and when a new data entry is stored, the report module 168 is initiated to inform the user or operator. The report module 168 filters at step 702, and the report database 172 on the in-perimeter target materials. In some embodiments, the report module 168 may send the entire dataset to the user. In some embodiments, the user or operator may be able to adjust the settings on detection network 160 to be notified of in-perimeter detections, specific target materials detected, whether inside or outside the perimeter, etc. The report module 168 extracts, at step 704, the data from the report database 172. The report database 174 may include a report ID, a first RF device ID, a second RF device ID, a timestamp, the target material, and the location relative to the perimeter. In some embodiments, the report ID may be a unique identifier for each report entry, which allows for easy referencing and management of individual detection events. In some embodiments, the first device ID may be the unique identifier of the first RF device involved in the detection event. In some embodiments, the second device ID may be the unique identifier of the second RF device involved in the detection event. In some embodiments, the timestamp may be the exact date and time when the detection event occurred, providing a temporal context for the detection results. In some embodiments, the target material may be the specific material that was detected, such as an explosive, chemical agent, or biological agent. In some embodiments, the perimeter result may indicate whether the detected target material is inside or outside the perimeter based on the combined detections of the first and second RF devices. For example, the ID module 166 begins by extracting the first entry from the target database 172 to check if an RF detection device 102 has detected a target material. The ID module 166 finds that the first RF detection device 102 has detected the target material, such as uranium, and the entry shows “yes.” The ID module 166 may then check the corresponding second RF detection device 102 to verify if it also detected the same material. If both devices have detected the target material, the ID module 166 determines that the material is inside the perimeter. The ID module 166 creates a new entry in the report database 174 with the detection data. In some embodiments, the report database 174 may be used by military bases to monitor entrances and sensitive areas to prevent unauthorized materials, such as explosives, chemical agents, and biohazardous substances, from entering the perimeter. In some embodiments, the report database 174 may be used by airports to enhance security by screening for explosives, narcotics, and biohazardous materials and the system may be located at various checkpoints, including entry gates and luggage handling areas. In some embodiments, the report database 174 may be used in the medical field for cancer detection by identifying cancerous tissues non-invasively by detecting specific biomarkers or cancer cells through RF signals. The report module 168 connects, at step 706, to the user device 176. In some embodiments, user devices 176 may include desktop computers, laptops, tablets, and smartphones to specialized equipment like industrial handhelds or medical diagnostic tools. In some embodiments, the user device 176 may include applications for the detection network 160 that are specific to the type of use of the detection system, such as military, airport security, medical field, etc. The report module 168 sends, at step 708, a notification to the user device 176 with the extracted data from the report database 172. The report module 168 may send a notification to the user device 176 that a target material has been detected within the perimeter. In some embodiments, the user may select the type of target materials that require a notification. In some embodiments, the report module 168 may send additional detection data to the user device 176, such as signal strength and frequency parameters. The report module 168 returns, at step 710, to the base module 162.

In another embodiment, the first receiver unit 124 detects the presence of a material near its location, and the partner device (second receiver unit) is positioned some distance away. By detecting the material first at the initial location and later at the second location, the system can calculate the travel time of the material between the two points. This can be particularly beneficial in monitoring the movement of hazardous materials or tracking the path of a biological contaminant, providing valuable data on the spread and speed of movement. This data is then sent to the base module 162, which processes the information and issues a report with the calculated travel time and geolocation details.

In another embodiment, the first receiver unit 124 detects a material, and a series of partner devices are placed in a line extending from the first unit. This setup can create a detection corridor, useful for monitoring the transit of materials through a specific pathway, such as a transport route or conveyor belt system. When the material is detected sequentially by the partner devices, the system can map the movement, direction, and speed, helping logistics and security operations to ensure that the material follows the intended path. The data collection module 164 continuously gathers this information and updates the report database 174 with real-time movement tracking.

In another embodiment, the first receiver unit 124 positioned at an entrance of a secured area with multiple partner devices arranged in a grid pattern within the area. This configuration allows for precise localization of the material within the grid. When the material is detected by multiple partner devices, the system triangulates the exact position, which is helpful for locating contraband, hazardous substances, or even lost items within a large facility. The perimeter database 170 is utilized to confirm the material's position relative to the grid, and a detailed report is generated for security personnel.

In another embodiment, the first receiver unit 124 and partner devices are deployed in a radial pattern around a high-value target or critical infrastructure. This setup forms a protective perimeter that can detect and locate any unauthorized material approaching the target from any direction. When a material is detected by any of the devices, the system calculates the distance and direction relative to the central target, enabling a rapid response to potential threats. The detection module 150 analyzes the data and sends immediate alerts through the communication network 160 to security teams.

In another embodiment, the first receiver unit 124 and partner devices are installed at different heights within a multi-story building or facility. This vertical arrangement allows for the detection and tracking of materials across different floors. When a material is detected at different heights, the system can determine its vertical movement, which is helpful in scenarios like monitoring the spread of smoke or gases in a building. The specific material database 156 provides the frequency data for accurate detection at various levels, and the results are stored in the report database 174 for facility management and emergency response planning.

In one embodiment, a network of RF material detection devices 102 could be installed across urban areas to continuously monitor air quality. By detecting specific pollutants like sulfur dioxide, nitrogen oxides, and particulate matter, the system could provide real-time data on air pollution levels, informing public health decisions and environmental policies. Another embodiment involves configuring RF detection devices 102 to monitor water sources for harmful substances such as heavy metals or toxic chemicals. By placing sensors upstream and downstream within a water body, the system could track the presence and movement of contaminants, aiding in environmental protection and public safety. In healthcare, RF detection devices 102 could be used to identify and track the presence of specific pathogens in hospital environments by setting up sensors in various sections of a hospital, such as patient rooms, operating theaters, and waiting areas, helping control the spread of infectious diseases by alerting staff when certain pathogens are detected. Additionally, in pharmaceutical settings, RF detection device 102 could verify the composition of drugs and ensure their authenticity, combating counterfeit medications in the supply chain. In industrial applications, RF detection devices 102 could be integrated into manufacturing lines to monitor the composition of materials being processed, ensuring that the materials meet quality standards and that the processes operate correctly by detecting impurities or deviations in real-time. RF detection devices 102 could also be strategically placed in industries handling hazardous materials, such as chemicals or radioactive substances, to detect any leaks or spills instantly, enhancing workplace safety by triggering immediate containment measures. In the agricultural sector, deploying RF detection devices 102 in agricultural fields could help analyze soil composition, detecting nutrients or contaminants like pesticides and heavy metals, guiding farmers in optimizing their fertilizer use and improving crop management practices. RF detection devices 102 could potentially be adapted to detect the early presence of pests by identifying the specific organic signatures associated with different species, allowing for timely pest control measures and reducing crop damage. In transport and logistics, RF detection devices 102 could be used at checkpoints for cargo screening to identify contents without opening containers, streamlining logistics operations while ensuring that prohibited or hazardous materials are not being transported. Mobile RF detection devices 102 could also be used for on-the-spot vehicle emissions testing, providing immediate feedback on pollutants being emitted, which could help enforce environmental regulations more effectively.

These embodiments demonstrate the versatility and effectiveness of using a network of RF material detection devices 102 with the system elements detailed, including the transmitter unit 106, the receiver unit 124, the control panel 146, and the detection network 160. Each setup offers specific benefits, from tracking movement and direction to providing precise location data, enhancing security, and improving operational efficiency in various applications.

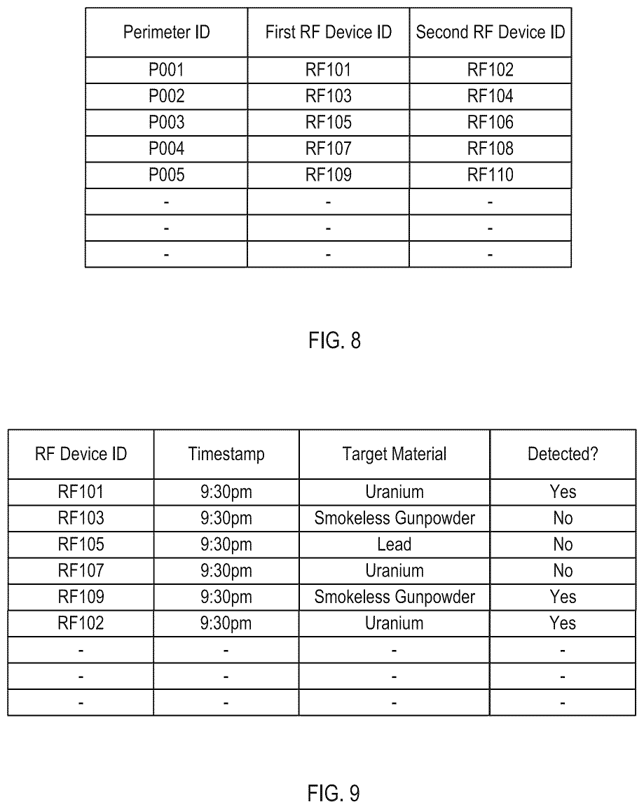

FIG. 8 illustrates the perimeter database 170. The perimeter database 170 may contain the pairs or combinations of RF detection devices 102 that are positioned to detect an area between one another. For example, if a first device is positioned to detect target materials in a north direction, a second device may be positioned north of the first device and positioned to detect target materials south direction. The RF detection devices 102 work together to detect specific target materials within the perimeter. The perimeter database 170 may contain a perimeter ID, a first RF device ID, and a second RF device ID. In some embodiments, the perimeter ID may be a unique identifier for each perimeter setup, used to reference and manage the perimeter as a distinct unit within the system. In some embodiments, the first RF device ID may be a unique identifier of the first RF device in the pair, responsible for detecting the presence of a target material and initiating the verification process. In some embodiments, the second RF device ID may be a unique identifier of the second RF device in the pair, which corroborates the detection of the target material by the first device. In some embodiments, the RF detection devices 102 may be set up in various configurations, such as in a straight line or positioned to look at one another, in a triangle, square, circle, etc. In some embodiments, the directional shield 142 of the RF detection devices may allow for a larger viewing angle to allow for a wider detection area. In some embodiments, the perimeter database 170 data entries may be pre-calibrated or calibrated by operators on the network. In some embodiments, the calibration may involve setting up the RF detection devices 102 at specific locations and ensuring they are properly aligned to monitor the designated perimeter area effectively. When the first RF detection device 102 detects a target material, it signals the system to query the paired second RF detection device 102. The second RF detection device 102, checks for the presence of the same target material. If the second device also detects the target material, the system concludes that the material is within the perimeter. If the second device does not detect the material, the system concludes that the material is outside the perimeter. In some embodiments, the detection results are stored for further analysis and reporting. In some embodiments, the RF detection devices 102 may be equipped with a GPS or global positioning system, and when the detection network 160 receives the data from the RF detection device 102, it may also receive the device's location. The positions of the RF detection devices 102 may be strategically deployed in various scenarios such as a school or along the border. In a school layout for detecting guns or drugs, sensors may be positioned at all entry and exit points to detect any contraband as it enters the school premises. Sensors may also be placed in common areas like cafeterias, hallways, and assembly areas where students gather in large numbers. Along the perimeter fence, sensors can monitor any unauthorized attempts to pass contraband over the fence. Locker areas may have sensors to detect stored contraband as students access their lockers throughout the day. Sports facilities, including sports grounds and gymnasiums, may be equipped with sensors due to the potential for these less supervised areas to be used for contraband exchange. In a border layout for detecting drugs and explosives, sensors may be integrated at all vehicle, pedestrian, and cargo inspection stations at official border crossings to screen for drugs and explosives systematically. Drones equipped with RF detection devices may patrol remote areas of the border where installing fixed sensors might not be feasible. Sequential sensor stations may be set up along suspected smuggling routes to catch any contraband that might evade initial detection. Sensors may be positioned near rivers and lakes that form part of the border to detect submerged packages of drugs or explosives. A bi-directional setup may be arranged to detect threats in both directions, monitoring not only incoming contraband but also the exit of domestically produced contraband.

FIG. 9 illustrates the target database 172. The target database 172 may be created in the process described in the data collection module 164, which collects the detection data from a plurality of RF detection devices 102, and the data may be analyzed in the process described in the ID module 166, which determines if the detected target material is within the perimeter. The target database 172 may contain the device ID, the timestamp the data was collected was by the RF detection device 102, the target material, and whether the target material was detected or not. In some embodiments, the target database 172 may contain the GPS location of each of the RF detection devices 102. In some embodiments, the detection data may include signal strength and frequency parameters. The signal strength measures the intensity of the detected signal, providing information about the proximity and concentration of the target material. The frequency data includes the specific RF frequencies that were detected, which may help in identifying the type of material based on its unique frequency signature. In some embodiments, this combination of signal strength and frequency data enables the system to differentiate between various substances and determine their presence with high accuracy. In some embodiments, the target database 172 may include environmental conditions, such as temperature, humidity, and atmospheric pressure, which may affect RF signal propagation and detection accuracy.

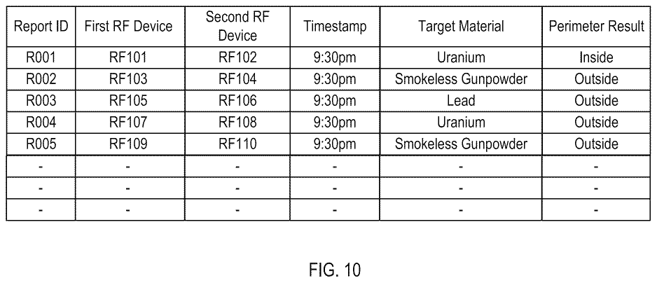

FIG. 10 illustrates the report database 174. The report database 174 may be created in the process described in the ID module 166, which stores the results of whether a target material is within or outside the perimeter and is used in the report module 168 to notify or inform a user or operator. The report database 174 may include a report ID, a first RF device ID, a second RF device ID, a timestamp, the target material, and the location relative to the perimeter. In some embodiments, the report ID may be a unique identifier for each report entry, which allows for easy referencing and management of individual detection events. In some embodiments, the first device ID may be the unique identifier of the first RF device involved in the detection event. In some embodiments, the second device ID may be the unique identifier of the second RF device involved in the detection event. In some embodiments, the timestamp may be the exact date and time when the detection event occurred, providing a temporal context for the detection results. In some embodiments, the target material may be the specific material that was detected, such as an explosive, chemical agent, or biological agent. In some embodiments, the perimeter result may indicate whether the detected target material is inside or outside the perimeter based on the combined detections of the first and second RF devices. For example, the ID module 166 begins by extracting the first entry from the target database 172 to check if an RF detection device 102 has detected a target material. The ID module 166 finds that the first RF detection device 102 has detected the target material, such as uranium, and the entry shows “yes.” The ID module 166 may then check the corresponding second RF detection device 102 to verify if it also detected the same material. If both devices have detected the target material, the ID module 166 determines that the material is inside the perimeter. The ID module 166 creates a new entry in the report database 174 with the detection data. In some embodiments, the report database 174 may be used by military bases to monitor entrances and sensitive areas to prevent unauthorized materials, such as explosives, chemical agents, and biohazardous substances, from entering the perimeter. In some embodiments, the report database 174 may be used by airports to enhance security by screening for explosives, narcotics, and biohazardous materials and the system may be located at various checkpoints, including entry gates and luggage handling areas. In some embodiments, the report database 174 may be used in the medical field for cancer detection by identifying cancerous tissues non-invasively by detecting specific biomarkers or cancer cells through RF signals. Other embodiments may include applications for a networked grid of RF detection devices 102 in transportation hubs, such as airports for enhanced monitoring of luggage and cargo for explosives, drugs, or other illegal items, train stations for detecting hazardous materials within passenger luggage or freight to ensure safe travel and compliance with regulations, and ports for monitoring shipping containers and vehicles for contraband or hazardous substances. In public safety and law enforcement, integration into smart city infrastructure to detect and respond to chemical or radioactive threats in real-time, use at large public events like concerts or sports to monitor for weapons or explosives, and detection of drugs, weapons, and contraband being smuggled into prisons may be implemented. In healthcare and pharmaceuticals, monitoring pharmacies and hospitals for the theft or misplacement of controlled substances and ensuring that hazardous medical waste is handled and disposed of properly may be considered. Environmental monitoring may include detecting leaks or spills of hazardous materials in industrial sites like chemical plants or refineries, monitoring waste management facilities for inappropriate or dangerous waste disposal, and detecting poaching activities or unauthorized entry in wildlife and nature reserves. In educational and research facilities, monitoring laboratories for the presence of specific chemicals to prevent unauthorized access or misuse and surveilling sensitive areas in universities to ensure the safety and security of research materials may be applied. Manufacturing and warehousing applications may include real-time monitoring of raw materials for quality control and safety in production lines and detecting hazardous material leaks or spills in warehouses to ensure compliance with safety regulations.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

1. A system for networked RF-based material detection, the system comprising:
a plurality of RF detection devices positioned along a perimeter of a defined area and including at least a first RF detection device located at a first side of the perimeter, the first RF detection device comprising:
an interface configured to access a material database associating each of a plurality of materials with one or more corresponding resonance frequencies;
an RF transmitter that transmits an RF signal at a resonance frequency into an environment for each material in at least a set of the materials;
an RF receiver that receives a response signal from the environment for each RF signal; and
one or more processors that execute instructions stored in memory, wherein the processor executes the instructions to:
analyze the response signal for resonance characteristics that indicate a presence of at least one of the materials in the set,
generate a first detection entry to store in a target database, the first detection entry including at least an identifier of the first RF detection device that received the response signal and detection data,
determine that at least one other detection entry associated with at least one other of the RF detection devices located at a second side of the perimeter also includes detection data that indicates the presence of the at least one material, and
store an indication that the at least one material is within the perimeter based on the first detection entry and the at least one other detection entry.

2. The system of claim 1, further comprising a perimeter database that stores information regarding a respective location of each of the RF detection devices along the perimeter.

3. The system of claim 1, wherein the first detection entry further includes a timestamp associated with the response signal indicating the presence of the at least one material.

4. The system of claim 3, wherein the processors identify the at least one other RF detection device based on the location of the first RF detection device or the timestamp.

5. The system of claim 1, wherein the detection data includes one or more of a signal strength parameter and a frequency parameter.

6. The system of claim 5, wherein the processors execute further instructions to use at least one of the signal strength parameter or the frequency parameter to determine one or more of a proximity and concentration of the at least one material.

7. The system of claim 1, wherein the detection data includes data regarding one or more environmental conditions that affect RF signal propagation or detection accuracy.

8. The system of claim 7, wherein the one or more environmental conditions include one or more of temperature, humidity, and atmospheric pressure.

9. The system of claim 7, wherein the RF transmitter further adjusts the resonance frequency of the RF signal based on at least one of the environmental conditions.

10. The system of claim 1, wherein the processors execute further instructions to generate a report regarding one or more of the materials identified within the perimeter.

11. The system of claim 1, wherein the processors execute further instructions to triangulate a location of the at least one material using known locations of the first RF detection device and the at least one other RF detection device.

12. A method for networked RF-based material detection, the method comprising:
storing information regarding a plurality of RF detection devices positioned along a perimeter of a defined area that includes at least a first RF detection device;
accessing a material database associating each of a plurality of materials with one or more corresponding resonance frequencies;
transmitting an RF signal using an RF transmitter at a resonance frequency, the RF signal transmitted into an environment for each material in at least a set of the materials;
analyzing the response signal for resonance characteristics that indicate a presence of at least one of the materials in the set;
generating a first detection entry to store in a target database, the first detection entry including at least an identifier of the first RF detection device that received the response signal and detection data;
determining that at least one other detection entry associated with at least one other of the RF detection devices located at a second side of the perimeter also includes detection data that indicates the presence of the at least one material; and
storing an indication that the at least one material is within the perimeter.

13. The method of claim 12, further comprising storing a perimeter database in memory that stores information regarding a respective location of each of the RF detection devices along the perimeter.

14. The method of claim 12, wherein the first detection entry further includes a timestamp associated with the response signal indicating the presence of the at least one material.

15. The method of claim 14, further comprising identifying the at least one other RF detection device based on the location of the first RF detection device or the timestamp.

16. The method of claim 12, wherein the detection data includes one or more of a signal strength parameter and a frequency parameter.

17. The method of claim 16, further comprising determining one or more of a proximity and concentration of the target material based on the signal strength parameter or frequency parameter.

18. The method of claim 12, wherein the detection data includes data regarding one or more environmental conditions that affect RF signal propagation or detection accuracy.

19. The method of claim 18, wherein the one or more environmental conditions include one or more of temperature, humidity, and atmospheric pressure.

20. The method of claim 18, further comprising adjusting the resonance frequency of the RF signal transmitted by the RF transmitter based on at least one of the one or more environmental conditions.

21. The method of claim 12, further comprising generating a report regarding one or more of the materials identified within the perimeter.

22. The method of claim 12, further comprising triangulating a location of the at least one material using known locations of the first RF detection device and the at least one other RF detection device.

23. A non-transitory, computer-readable storage medium having embodied thereon a program executable by a processor to perform a method for networked RF-based material detection, the method comprising:
storing information regarding a plurality of RF detection devices positioned along a perimeter of a defined area that includes at least a first RF detection device;
accessing a material database associating each of a plurality of materials with one or more corresponding resonance frequencies;
transmitting an RF signal using an RF transmitter at a resonance frequency, the RF signal transmitted into an environment for each material in at least a set of the materials;
receiving a response signal from the environment for each RF signal;
analyzing the response signal for resonance characteristics that indicate a presence of at least one of the materials in the set;
generating a first detection entry to store in a target database, the first detection entry including at least an identifier of the first RF detection device that received the response signal and detection data;
determining that at least one other detection entry associated with at least one other of the RF detection devices located at a second side of the perimeter also includes detection data that indicates the presence of the at least one material; and
storing an indication that the at least one material is within the perimeter.
